(19) United States
(12) Patent Application Publication
(10) Pub. No.: US 2017/0263034 A1
(43) Pub. Date: Sep. 14, 2017

(54) SYSTEMS AND METHODS FOR SCALE CALIBRATION IN VIRTUAL DRAFTING AND DESIGN TOOLS

(71) Applicant: Morpholio LLC, Raleigh, NC (US)

(72) Inventors: Jeffrey Kenoff, Bedford, NY (US); Anna Kenoff, Bedford, NY (US); Toru Hasegawa, Brooklyn, NY (US); Mark Collins, Brooklyn, NY (US)

(21) Appl. No.: 15/458,858

(22) Filed: Mar. 14, 2017

Related U.S. Application Data
(60) Provisional application No. 62/307,933, filed on Mar. 14, 2016.
(60) Provisional application No. 62/365,174, filed on Jul. 21, 2016.

(51) Int. Cl. G06T 11/60; G06F 3/0354; G06F 17/50; G06F 3/0484; G06T 11/20; G06F 3/0488; G06T 11/00; G06T 3/40

(52) U.S. Cl. CPC G06T 11/60; G06T 11/001; G06F 3/03545; G06T 3/40; G06F 3/04845; G06T 11/203; G06F 3/04842; G06F 3/0488; G06F 17/5004; G06F 2203/04808; G06F 2203/04806

(57) ABSTRACT

Systems and methods for computer-aided or virtual drafting and design are described. Such systems and methods provide a virtual drafting space with the capability of providing multiple layers, magnifications, and scale sensitivity such that a draftsperson can navigate through the virtual drafting space through simple touch commands on a multi-touch interactive screen or through other inputs. As the draftsperson changes the magnification environment of the drawing, the systems and methods provide a set of drafting instruments calibrated for use with the particular environment chosen and scale within that environment, including a stencil capable of being locked to correlate to its scale in the virtual environment regardless of magnification level.

### CROSS-REFERENCE TO RELATED APPLICATIONS

This application relies on the disclosure of and claims priority to and the benefit of the filing date of U.S. Provisional Application No. 62/307,933 filed Mar. 14, 2016 and U.S. Provisional Application No. 62/365,174 filed Jul. 21, 2016, the disclosures of each of which are hereby incorporated by reference herein in their entireties.

### BACKGROUND OF THE INVENTION

Field of the Invention

The present invention relates to the field of computer-aided drafting and design or virtual drafting and design through software, which may be used in architecture, home improvement, interior design, landscape design, and other applications.

Description of Related Art

Computer aided drafting, or so-called CAD, software extends physical toolsets with vector-based techniques that allow for drafting physical objects in a virtual space. However, this relatively dated, but still widely used drafting software, is inadequate to the task of allowing high precision, scale sensitive drawing with touch input, especially for architectural blueprints and schematics. What is needed are a set of tools that provide intelligent solutions to create precise scale drawings for drafting, sketching and illustrating.

In architecture specifically, a problem with drafting large scale objects such as buildings, infrastructure, and landscapes is that they cannot be created on a 1:1 scale. So in the past, an architect would draw on paper a “scale” drawing, make “scale” models that would have a “Scale Factor” that if multiplied to features in the drawing would convert them to the real 1:1 scale version. However, with the arrival of the computer and computer graphics the concept of the “virtual space” was introduced. In this computer “virtual space”, the architect was somewhat liberated to draw or model in the actual 1:1 scale. However, drawing applications which provided this virtual space still required viewing architectural features on a screen that is relatively similar in size to that of paper.

Current drawing applications and software provide a basic set of virtual drafting instruments (e.g. “pens” or “brushes”) with particular types and thicknesses for draftspersons to choose from. As every line thickness in architectural applications has meaning, these pens require a controlled technical thickness (line weight) and need to maintain this calibration as it relates to where it exists in any drawing at any given place and time. However, current drawing applications and software do not provide appropriate choices of virtual drafting instruments that are adjustable according to changes in scale inside the drawing, such as at various magnification levels of the virtual environment, such as the canvas or layer. Thus, like any art there is room for improvement, and the current state of the art does not provide an intelligent solution to instantly imbue scale to a drawing. Ideally, these tools will have unique capabilities that enable precision drawing while accepting imprecise touch input and will work in unison to provide flexible and intuitive workflows to users.

### SUMMARY OF THE INVENTION

Embodiments of the present invention provide systems and methods for virtual drafting and design. In one embodiment, the systems and methods provide a virtual drafting space such that a draftsperson can create different scaled environments, or magnifications, through direct user input, such as for example by zooming in or out of a virtual “scene”, or indirectly by indicting through selection that a particular layer of the drawing should fill the screen, or through entering a specific desired magnification such as 1:1. As the draftsperson dynamically changes the magnification environment of the drawing, the systems and methods provide a set of virtual drafting instruments with various line weights for the draftsperson to choose from. The set of line weights are appropriately calibrated based on the particular magnification environment chosen, and allow the draftsperson to create drawings for that magnification environment with lines having thicknesses that are appropriate for that environment. Thus, the systems and methods allow the draftsperson to make a set of related or unrelated drawings at one or more or multiple scales while maintaining integrity of the dimensioned features inside the drawing(s). For example, in the case of architecture, this allows a draftsperson to produce, select, and dynamically navigate through a set of multiple drawings at the site plan level, structure plan level, floor plan level, and room level, as well as architectural detail level, while maintaining standard line weights for each level as well as providing context appropriate choices of line weights for drafting instruments for each level.

In another embodiment of the present invention, an “Interactive Scale” tool is provided that allows for inputting scale to a series of free-placed layers. For example, if the user designates two points in the virtual environment that correspond to some present features in the drawing and inputs the known distance between those two points in physical reality, the system will determine a scale factor for the entire drawing. Thus tools can be annotated with appropriate scale information. Typical elements in drawings can be suitable for this method, for example, objects present in the virtual environment such as doors, dimension lines, or walls, or even a drawn scale. This unique, inputted scale information will propagate to all other layers and scale-sensitive linked tools. Thus, a scale is registered; it synchronizes for the virtual space-scale in the same schematic (or related schematics), and tools and other drafting aspects do not require reconfiguration. A system to lock/unlock layers from undesired scaling is also taught, so scaling can be selectively manipulated.

The system's visual embodiments include a registration system for two points, which are chosen in a virtual environment and a scalable measurement is entered, such as distance (e.g., in feet). The system also includes multiple visual indicators (such as ruler) that give live updates to scale changes and ambient awareness of relative scale.

Objectives of embodiments described herein include a reduction of significant time for the user, the ability to change or adjust scale quickly and to automatically coordinate scale changes to all corresponding scale-sensitive tools. Embodiments of a system and method for providing “Interactive Scale” provide scale automatically from two methods. First, a “Dimension Mode” in which a user supplies a known dimension that includes two reference points and a known dimension and unit of measure. A second mode includes “Relative Mode”.

Embodiments include decoration of scale sensitive tools such as a ruler or triangle with dimensional callouts and tick marks that provide an ambient sense of scale and dimensional accuracy while drawing at any zoom level.

Embodiments of a system and method for providing a scale-sensitive “Stencil” are taught allowing users to automatically generate masking stencils from photos and other user-supplied imagery. The scale of the stencil contents may be set, which enables the software to automatically fit the stencil to an arbitrary virtual environment in such a way that stenciled shapes are drawn at the appropriate size and scale to correspond with other scale elements.

Aspects of embodiments include a method of computer-aided drafting, comprising: providing a first set of virtual writing instruments; providing a virtual environment at a magnification level; determining a change in the magnification level of the virtual environment; and providing a second set of virtual writing instruments in response to the change.

Such methods can include methods wherein: the second set of writing instruments comprises at least one writing instrument with a line weight that is not available in the first set; or the first set of writing instruments comprises at least one writing instrument with a line weight that is not available in the second set.

Alternatively or in addition, the methods can include wherein the first or second set has at least one writing instrument: (i) with a line weight that is different from a line weight of any of the writing instruments in the other set of writing instruments, and/or (ii) with a line weight that reflects the minimum line weight appropriate for the magnification level of the virtual environment.

Aspects of the methods described herein include methods wherein: each of the writing instruments has an associated line weight; and/or the smallest line weight available to a user is the smallest line weight appropriate for the magnification level of the virtual environment. In embodiments, the smallest appropriate line weight can be about 1-2 pixels wide.

Methods can comprise updating a user interface with a graphical display of the first and/or second set of virtual writing instruments, especially in response to a change in the magnification level of the drawing environment.

In embodiments, the tools, for example the drafting instruments such as the pens and/or brushes, can be color coded to correspond with a particular line weight.

The methods include methods wherein one or more of the writing instruments has an associated line weight and one or more of the line weights differs from another of the line weights in the set of writing instruments by a factor of the square root of 2. In embodiments, one or more of the line weights can be calculated according to the formula: F(x)=i×s^{x}, where s stands for the square root of 2 and i stands for the initial value or base value.

Methods included in the scope of the invention include a method of providing scale using a computer, comprising: providing a virtual environment; determining the magnification level of the virtual environment; receiving user inputs on a defined value between two points in the virtual environment, or providing a predetermined scale displayed in the virtual environment; setting a space-scale relationship between the determined magnification level of the virtual environment and the defined value or the predetermined scale; and in response to changes in the magnification level of the virtual environment, calculating the scale appropriate for the magnification level based on the set space-scale relationship between the determined magnification level and the defined value or the predetermined scale.

The scale in such method embodiments can be provided to a stencil, shape, or other object displayed in the virtual environment. In embodiments, the predetermined scale can be an object of known or approximate scale, such as a person, animal, figure, vehicle, door jamb, or scale key.

User inputs together can represent a known distance in a real-world environment between the two points.

Alternatively or in addition, a feature of one or more tools presented in such methods can be chosen from virtual rulers, virtual drafting triangles, virtual drafting compasses, and/or line weights of virtual drafting instruments and can be adjusted to a selected scale registration factor to maintain the set space-scale relationship.

In embodiments, the scale can be provided to a virtual stencil and the set space-scale relationship between the virtual environment and the virtual stencil applies to position and/or rotation of the virtual environment and/or the virtual stencil relative to one another.

Additional methods relate to computer-aided creation of a virtual stencil, comprising: providing a source image; reading each pixel in the source image and comparing each pixel with a threshold value; assigning pixels a white color when the pixel exceeds the threshold value and assigning pixels a black color when the pixel equals or falls below the threshold value; and creating a virtual stencil as a black and white mask from the source image by storing the black pixels as alpha values creating an RGBA channel image.

According to such methods, the methods can allow an option to accept more or less of the source image to create the virtual stencil.

The virtual stencil according to embodiments can be configured to preserve scale relationships between a virtual environment and content of the virtual stencil. For example, the virtual stencil can be configured to be adjusted using horizontal mirroring, vertical mirroring, scale lock, rotation lock, inverse, and/or auto fill.

According to method embodiments, the virtual stencil is configured to allow for masking of subsequent drawing operations.

Embodiments also include methods of computer-aided drafting, comprising: providing a set of virtual writing instruments, each having an associated line weight; providing a virtual environment with a desired magnification level; in response to a change in the magnification level of the virtual environment, determining a minimum line weight appropriate for the magnification level of the virtual environment; and modifying the set of virtual writing instruments to include as the smallest virtual writing instrument available to a user at least one virtual writing instrument having the minimum line weight appropriate for the magnification level of the virtual environment.

Further method embodiments provide methods of computer-aided drafting, comprising: providing a first set of virtual writing instruments, each having an associated line weight; providing a virtual environment with a desired magnification level; in response to a change in the magnification level of the virtual environment, determining a minimum line weight appropriate for the magnification level of the virtual environment; and providing a second set of virtual writing instruments, wherein either the first or second set of virtual writing instruments has at least one virtual writing instrument with a line weight: that is different from a line weight of any of the virtual writing instruments in the other set of virtual writing instruments, and reflects the minimum line weight appropriate for the magnification level of the virtual environment.

Method embodiments also include methods of computer-aided drafting, comprising: receiving user inputs relating to a magnification level of a virtual environment; determining the magnification level of the virtual environment; and presenting a set of virtual writing instruments appropriate for the determined magnification level of the virtual environment.

Even further, embodiments include methods for computer-aided scaling of a virtual stencil, comprising: providing a virtual environment; providing a virtual stencil; allowing the virtual environment and/or virtual stencil to be resized; allowing a user to lock the relationship between the virtual environment and the virtual stencil so that the space-scale relationship between the virtual environment and the virtual stencil is maintained as the magnification level of the virtual environment or the virtual stencil are changed.

Methods of virtual drafting are included which comprise: providing a set of absolute line weights; monitoring for changes in magnification level on a user interface; and calculating a minimum line weight based on a magnification level chosen on the user interface.

Embodiments also include methods comprising: updating the user interface with a graphical display of the minimum line weight and/or updating the user interface with a graphical display of a subset of the set of absolute line weights based on the minimum line weight.

Further included are methods of virtual drafting, comprising: providing a user interface; receiving user inputs on the user interface; determining a magnification level on the user interface based on the user inputs; and defining a pen set capable of virtual drafting according to the magnification level. Such methods can include updating the user interface with a graphical display of the pen set based on the magnification level.

### BRIEF DESCRIPTION OF THE DRAWINGS

The accompanying drawings illustrate certain aspects of embodiments of the present invention, and should not be used to limit the invention. Together with the written description the drawings serve to explain certain principles of the invention.

FIG. 1A is a schematic diagram of an embodiment of a system for implementing methods of the invention.

FIG. 1B is a schematic diagram of an embodiment of a computing device for implementing methods of the invention.

FIG. 2 is a schematic illustration of a user interface according to an embodiment of the invention.

FIGS. 3A-3B are schematic illustrations of a user interface showing the effect of a two finger zoom input on the choice of available drafting instruments according to an embodiment of the invention.

FIG. 4A is a schematic illustration of a user interface showing the effect of a single tap input on a tab (representing access to a single specific layer of the drawing) of a layer manager interface, which effect makes available to the user a choice of available drafting instruments according to an embodiment of the invention.

FIG. 4B is a flow chart explaining the series of steps shown in FIG. 4A.

FIG. 5 is a flow chart of a method according to an embodiment of the invention.

FIGS. 6A-6D are screen shots of a user interface according to embodiments.

FIG. 7 is a schematic diagram showing that the device screen display can remain constant to physical space regardless of the zoom level, as well as how a certain selected brush size would appear in each of different magnification environments.

FIG. 8A shows a representative formula for calculating absolute line weights.

FIG. 8B is a table of exemplary line weights calculated with the FIG. 8A formula.

FIG. 9 shows a formula for calculating the preview size of the line weights in the preview interface as well as fixed and variable regions of the images in the preview interface.

FIG. 10 shows a formula for calculating an appropriate (e.g., the best) line weight for a particular magnification of scene.

FIG. 11 is a schematic diagram showing the relationship between the preview interface and scene scale.

FIG. 12 shows exemplary hand gestures for use with the user interface on a multi-touch interactive screen according to an embodiment of the invention.

FIG. 13A is a schematic illustration of a user interface according to an embodiment of the invention wherein scale is imbued to the virtual environment using “Dimension Mode”.

FIG. 13B is a schematic illustration of a user interface according to an embodiment of the invention wherein scale is imbued to the virtual environment using “Relative Mode”.

FIGS. 14A-B represent screen shots of user interfaces according to embodiments of the invention showing different user interfaces for imperial vs. metric units.

FIG. 15A, FIG. 15B, and FIG. 15C are flow charts of methods according to an embodiment of the invention.

FIG. 16 is a schematic illustration of a user interface according to an embodiment of the invention wherein scale is imbued to the virtual environment using “Dimension Mode.”

FIG. 17 is a schematic illustration of a user interface according to an embodiment of the invention wherein scale is imbued to the virtual environment using “Relative Mode.”

FIG. 18 is a set of screen shots of user interfaces according to embodiments.

FIG. 19 is a set of screen shots of user interfaces according to embodiments.

FIG. 20 is a screen shot of a user interface according to embodiments.

FIG. 21 is a screen shot of a user interface according to embodiments.

FIG. 22 is a screen shot of a user interface according to embodiments.

FIG. 23 is a pictorial flow chart of a method according to embodiments.

FIG. 24 is a narrative and pictorial flow chart of a method according to an embodiment of the invention.

FIG. 25 is a flow chart of a method according to an embodiment of the invention.

FIG. 26 is a flow chart of a method according to an embodiment of the invention.

FIG. 27 is a set of screen shots of user interfaces according embodiments.

FIG. 28 is a screen shot of a user interface according to embodiments.

FIG. 29 is a flow chart of a method according to an embodiment of the invention.

FIG. 30 is a pictorial flow chart of a method according to embodiments.

FIG. 31 is a pictorial and narrative description of a method according to an embodiment of the invention.

FIG. 32 is a graphic and representative algorithm for custom stencil creation.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

The current invention allows a user, such as an architect, to seamlessly draw, sketch, and plan within a virtual blueprint all aspects of such a schematic, without having to constantly switch scale, tools, and other aspects of the environment.

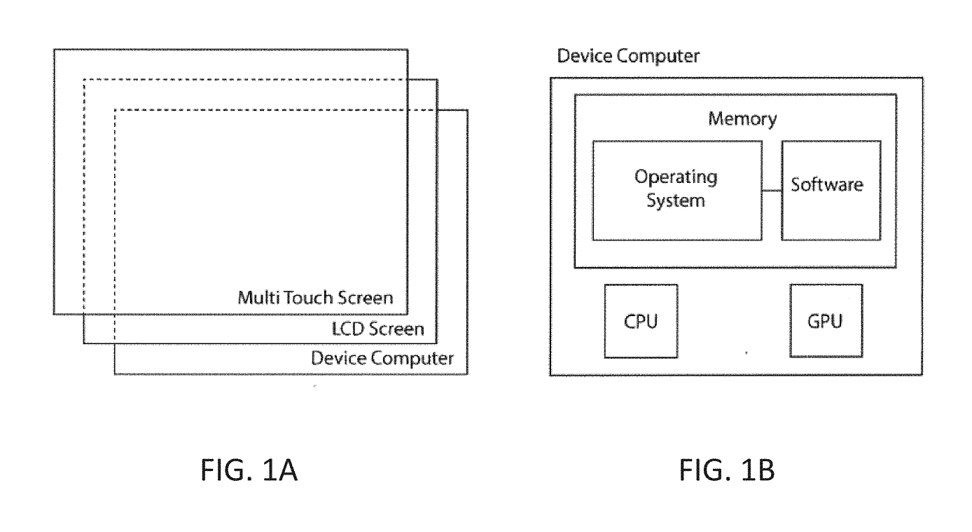

FIGS. 1A and 1B describe an embodiment of a system useful for implementing methods of the invention. The system can include various hardware components including a computing device with a multi-touch interactive screen (FIG. 1A). However, other embodiments employ a conventional (non-touch) computer screen or monitor such as a conventional LCD screen. In embodiments, the computing device can be a mainframe computer, desktop computer, laptop, tablet, netbook, notebook, personal digital assistant (PDA), gaming console, e-reader, smartphone, or smartwatch. Other components of the computing device, shown in FIG. 1B, can include a processor (CPU), graphics processing unit (GPU), and non-transitory computer readable storage media such as RAM and a conventional hard drive. Other components of the computing device can include a database stored on the non-transitory computer readable storage media. As used in the context of this specification, a “non-transitory computer-readable medium (or media)” may include any kind of computer memory, including magnetic storage media, optical storage media, nonvolatile memory storage media, and volatile memory. Non-limiting examples of non-transitory computer-readable storage media include floppy disks, magnetic tape, conventional hard disks, CD-ROM, DVD-ROM, BLU-RAY, Flash ROM, memory cards, optical drives, solid state drives, flash drives, erasable programmable read only memory (EPROM), electrically erasable programmable read-only memory (EEPROM), non-volatile ROM, and RAM. The non-transitory computer readable media can include a set of computer-executable instructions for providing an operating system for the device as well as a set of computer-executable instructions, or software, for implementing the methods of the invention. The computer-readable instructions can be programmed in any suitable programming language, including JavaScript, C, C#, C++, Java, Python, Perl, Ruby, Swift, Visual Basic, and Objective C.

The non-transitory computer-readable medium or media can comprise one or more computer files comprising a set of the computer-executable instructions for performing the processes, operations, and algorithms of the methods of the invention. In exemplary embodiments, the files may be stored contiguously or non-contiguously on the computer-readable medium. Embodiments of the invention may also include a computer program product comprising the computer files, either in the form of the computer-readable medium comprising the computer files and, optionally, made available to a consumer through packaging, or alternatively made available to a consumer through electronic distribution such as downloading from the internet.

Other components of the computing device can include network ports (e.g. Ethernet) or a wireless adapter for connecting to the Internet, input/output ports (e.g. USB, PS/2, COM, LPT), a mouse, a keyboard, a microphone, headphones, and the like. Under control of the operating system, the software programs for implementing the methods of the invention can be accessed via an Application Programming Interface (API), Software Development Kit (SDK) or other framework. In general, the computer-executable instructions for implementing the methods, and/or data, are embodied in or retrievable from the disk space or memory of the device, and instruct the processor to perform the steps of the methods.

Additional embodiments may include or be enabled in a networked computer system for carrying out one or more of the methods of this disclosure. The networked computer system may include any of the computing devices described herein connected through a network. The network may use any suitable network protocol, including IP, TCP/IP, UDP, or ICMP, and may be any suitable wired or wireless network including any local area network, wide area network, Internet network, telecommunications network, Wi-Fi enabled network, or Bluetooth enabled network.

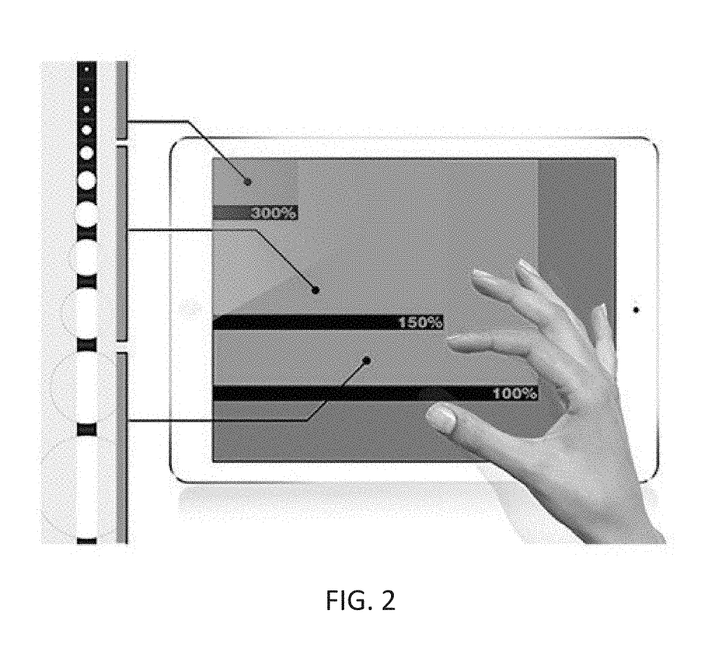

Turning next to FIGS. 2, 3A-3B and 4A-4B, embodiments of a user interface provided by the set of computer executable instructions are shown. FIG. 2 is an illustrative example of a feature of the software program when implemented on any of the aforementioned computing devices, which shows particular features of the interface. In this figure, the size of a virtual scene being zoomed in or magnified (i.e. 300%, 150%, 100%) relative to the screen size of the device is shown by the series of boxes. The hand over the screen indicates that a multi-touch gesture initiates the zooming. The left side of the figure shows a vertical bar with progressively larger circles, which graphically represent line weights of the virtual drafting instruments (e.g. pens or brushes) available for a draftsperson to choose (this vertical bar is also referred it herein as a “preview interface” and will be discussed in more detail). As used herein, “line weight”, “pen size”, “brush size”, and “stroke size” may be used interchangeably.

As shown in FIG. 2, as a user zooms in on the virtual scene, the set of line weights available to the draftsperson in the preview interface becomes smaller. Thus, at 100%, only the bottom two (largest) line weights are shown to be available in a set. At 150%, the middle five line weights are available in a set. At 300%, only the top smallest four line weights are available in a set. However, it should be pointed out that this figure is merely an illustration of the relationship between the level of zoom on the virtual scene and the relative size of the line weights available. The particular line weights and the actual number of line weights available in a set can be different for each zoom level. The relationship between zoom level and available line weights will be further discussed below.

Once the set of line weights is made available, the draftsperson can choose a particular line weight for use with a virtual drafting instrument (e.g. pen, brush, etc.). When selected the line weight will remain highlighted. The virtual drafting instrument can be a variety of brush or pen types. In addition to having its own line weight, each instrument can have its own color and specific opacity. An opacity slider or similar feature can be used to set the intensity of each line. As the user zooms in and out of the scene, the line weights automatically change in the preview interface to show the available optimal line weights for that particular magnification.

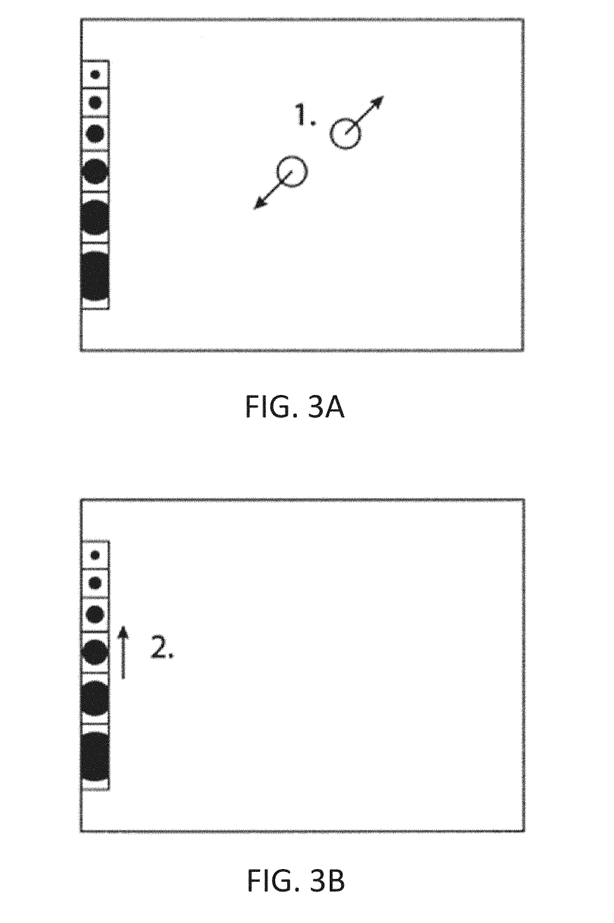

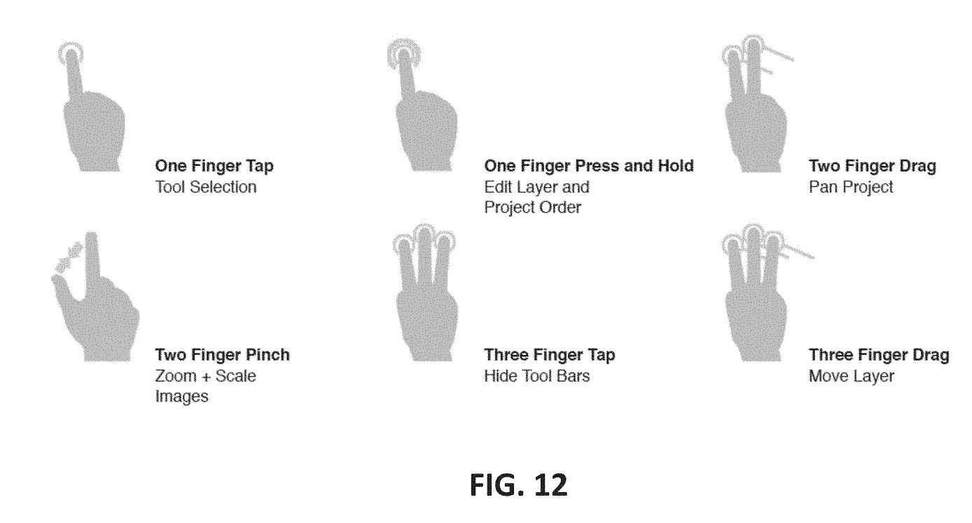

FIG. 3A illustrates that a draftsperson may initiate a change in drafting environment through a multi-touch gesture. The circles 1 in FIG. 3A represent contact points of two fingers being moved apart such that a “zoom-in” command is initiated to the program. Other gestures can also be used such as swiping up with a single finger. Such commands result in a change in the scene of the drafting environment where the virtual scene is magnified. As a result, the program automatically adjusts the set of available line weights of the virtual drafting instrument to the newly adjusted context, as illustrated by the arrow labeled 2 in FIG. 3B. For example, as shown in FIG. 3B, zooming-in results in automatic selection of a set of line weights with smaller thicknesses. Conversely, zooming-out (e.g. moving two fingers together, or swiping down with a single finger) will result in automatic selection of a set of line weights with larger thicknesses proportional to the increase in zoom. However, in other embodiments, the particular commands for zooming in and zooming out may be reversed (e.g. two fingers being moved apart “zooms out” and two fingers being moved together “zooms in”). Further, it should be noted that the present invention contemplates other types of touch commands for initiating a zooming in or zooming out function, including a number of taps on the screen, a one finger command (e.g. swiping left or right, or up or down), and the like. The particular touch commands or gestures shown in FIG. 3A are merely illustrative, and a skilled artisan is capable of implementing a variety of different touch commands for initiating zooming in or out of any particular layer. Additionally, the present invention contemplates the use of other (e.g. non-touch) commands to initiate zooming in or zooming out, such as choosing from set values from a dropdown menu, scrolling through values on a slider, entering a specific zoom value, instructing the computer to configure the zoom so that the scene or a specific layer fills the screen, etc. The other commands can be initiated through standard devices such as a mouse or keyboard such that a multi-touch interface is not required, or can be initiated through a multi-touch interactive screen. The present invention contemplates a variety of commands for initiating a zoom function or other functions on a screen which can be appreciated by a person of ordinary skill in the programming arts. Exemplary touch commands that may be useful for implementing the methods of the invention are shown in FIG. 12.

The line weights of the virtual drafting instrument may vary from one another based on a fixed scale to provide standard widths used in drafting. In other embodiments, the line weights of the virtual drafting instruments may vary by a scale set by the draftsperson. In one embodiment, the virtual drafting instruments vary from one another in terms of line weight by a factor of the square root of two (approximately 1.41) and thus in this way may be standardized for use in architectural applications.

Further, in some embodiments the set of virtual drafting instruments presented to a user may be color-coded on the user interface to represent particular line weights or sizes, such as bright red represents the thickest line available and violet represents the thinnest available (or vice versa), or a combination of line weight and color coding can represent meaning. The entire range of available line weights is correlated with a fixed color gradient. Thus each line weight has a color associated with it that does not change even as the set of line weights changes with zooming. The preview interface displays these beside the line weights as an additional memory aid to allow the user to recognize a desired pen weight.

Further, in embodiments, the smallest pen appropriate for a particular scale represents 1-2 pixels on the screen of the computing device. In embodiments, the set of line weights provided for each particular magnification may include 2, 3, 4, 5, 6, 7, 8, 9, 10 or more line weights for a draftsperson to choose from to assign to a particular virtual drafting instrument. Further, the total number of line weights provided by the software may be 20, 25, 30, 35, 40, 45, 50, 55, 60, 65, 70, 75, 80, 85, 90, 95 or 100 or more to accommodate a wide array of magnification levels.

According to some embodiments, the user interface provides for a virtual environment, which may also be referred to as a layer or a series of various “layers” for drafting with a virtual drafting instrument. According to this disclosure, the virtual environment or “layer” can be a page of the virtual drafting space that provides for content (e.g. lines, symbols) initiated by the draftsperson to be recorded. According to more conventional terms, it can be thought of as the virtual equivalent of a physical “transparency” sheet (although while layers can be transparent they need not be as elaborated below). According to this disclosure, “magnification levels” are simply the level of zoom on any particular virtual environment/layer/canvas/space/scene. A layer may also be referred to as a canvas herein. According to this disclosure, the virtual drafting “space” can be thought of as a portion of or the entire content available to the draftsperson, which can include multiple environments, layers, canvases, spaces and magnification levels. According to this disclosure, a “scene” can be part of or the entirety of the layers and other contents of a drawing, whose visibility, or the portion that appears on the display of the computing device, can vary according to zoom level/magnification.

According to some embodiments, the layers are completely transparent or allow a user to set a level of transparency, such as 10%, 20%, 30%, etc., where 100% is completely transparent and 0% is completely opaque. The layers can be transparent, or partially transparent, except for the line, drawing, or other content contributed by draftsperson. According to embodiments, the layers can be stacked on top of each other such that when the layers have some level of transparency, drawing content from successive layers is shown overlaid on top of each other. Further, embodiments allow layers to be added or removed to the virtual scene so that only select layers are included.

According to some embodiments, layers have a unique placement and, either determined by the system or by input from the draftsperson. For example, the layers can be provided sequentially from the smallest size to the largest size or the largest unit to the smallest unit, or randomly sized. The size and placement of a new layer may also be inferred by determining the size and placement of the smallest rectangle that completely covers the screen. In other embodiments a user is allowed to set the level of magnification of the scene by zooming or fitting to a layer to the device frame. Once a particular level of magnification is chosen, a series of best or most appropriate set of line weights are made available to the draftsperson and scale sensitive tools are updated with new information such as dimensional tick marks and call outs. Further, in some embodiments, when the device is rotated the scene will automatically adjust magnification to fit the scene or a chosen layer to the screen.

In embodiments, icons on a user interface allow a draftsperson to shift through layers by selecting (e.g. tapping on) a particular icon on the user interface. Further, embodiments allow a draftsperson to add, delete, or rearrange layers. Additionally, embodiments provide an interface for naming, renaming, resizing, repositioning, clearing the content, deleting, copying, locking, and mirroring the layers.

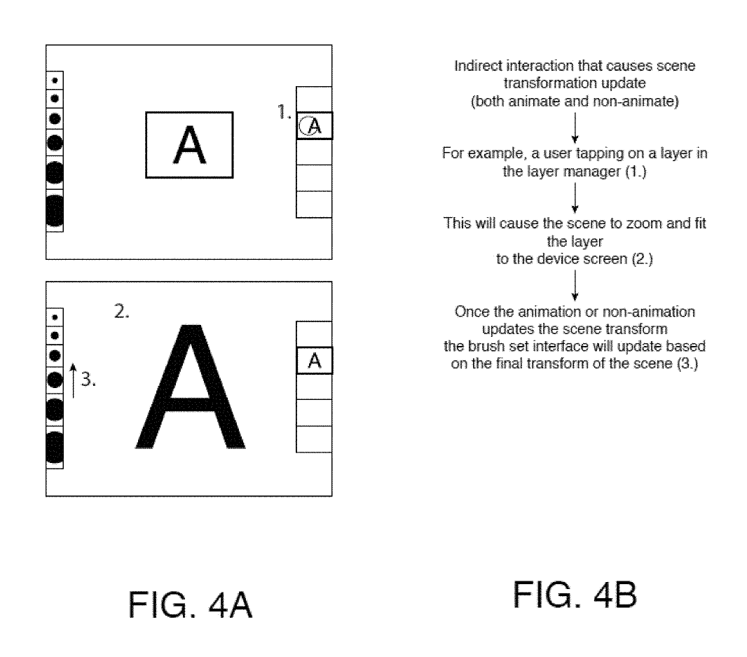

In embodiments, as a draftsperson navigates among layers, or magnifies or reduces the scale of the scene by zooming or initiating a zoom, line weights that are appropriate for the particular magnification are automatically selected as potential choices in a set of instruments, while line weights that are too small or too large are either not shown or grayed out to indicate the selection is not appropriate for the particular magnification. In one embodiment, shown in FIG. 4A, a layer manager interface is shown on the right side of the top and bottom screens as a vertical set of boxes. A circle 1 in the second box from the top represents a contact point of a draftsperson's finger or stylus, or click of mouse, etc. on the layer manager interface, indicating a selection of a particular layer. Such selection initiates the program to automatically display the selected layer and fit the layer to the device screen (shown by 2) and to automatically adjust the set of line weights for the virtual drafting or drawing instruments available for that layer (shown by 3). Thus, FIG. 4A shows that initiating selection of the particular layer automatically adjusts the set of line weights for the virtual drafting instrument for the magnification level of the particular layer. In this example a smaller set is available to the draftsperson, while a larger set is grayed out or otherwise not available for selection. Further, it should be noted that the layer manager interface as shown in FIG. 4A is merely an example, and that the present invention contemplates other interfaces for choosing a layer which can be appreciated by a skilled artisan, including entering a number for the layer, navigating a scroll bar or menu, and the like. FIG. 4B depicts a flow chart that describes the process shown in FIG. 4A.

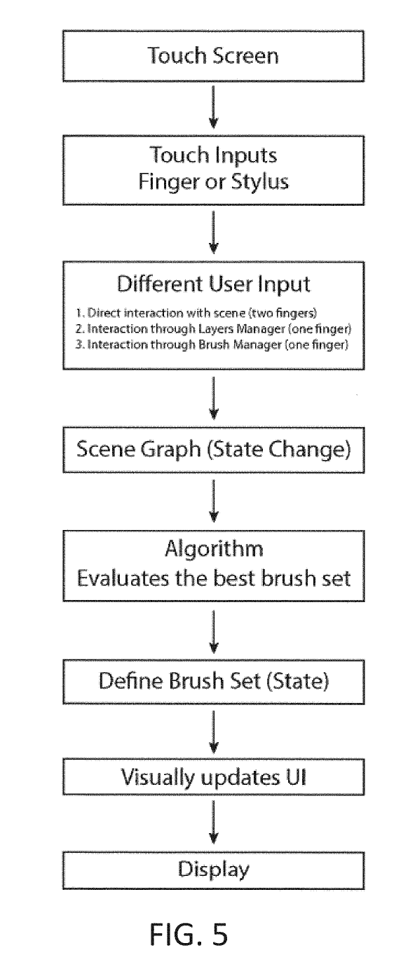

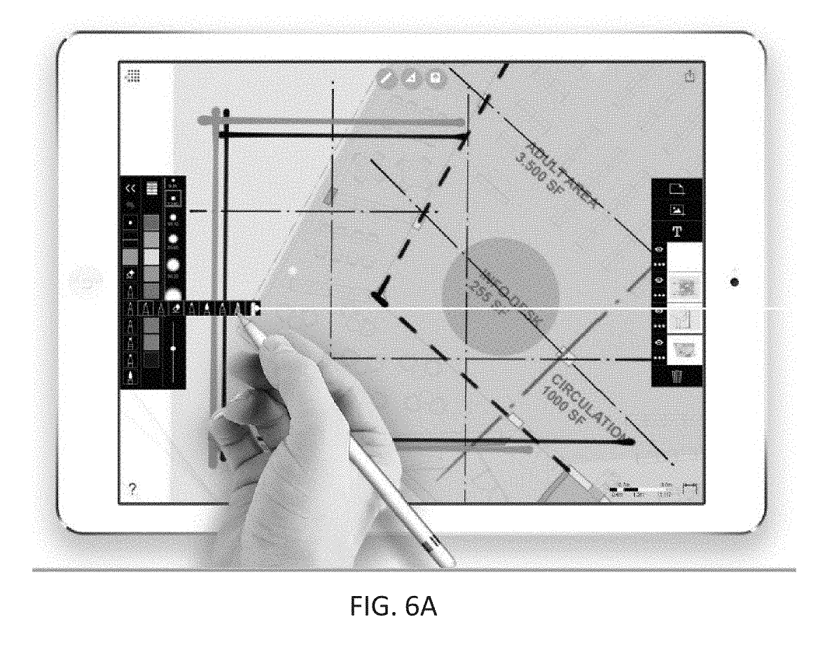

FIG. 5 is a flow chart illustrating a set of steps according to an embodiment of a particular method of the invention. The steps include providing a touch screen, receiving user inputs, processing user inputs, changing the state of the touch screen display at a particular magnification level chosen from the inputs, algorithmically evaluating the best set of virtual drafting instruments, defining the best set of virtual drafting instruments, visually updating the user interface, and redisplaying the touch screen display based on the inputs, selections and processing. In embodiments, the best set of virtual drafting instruments is calibrated/scaled to the particular chosen magnification.

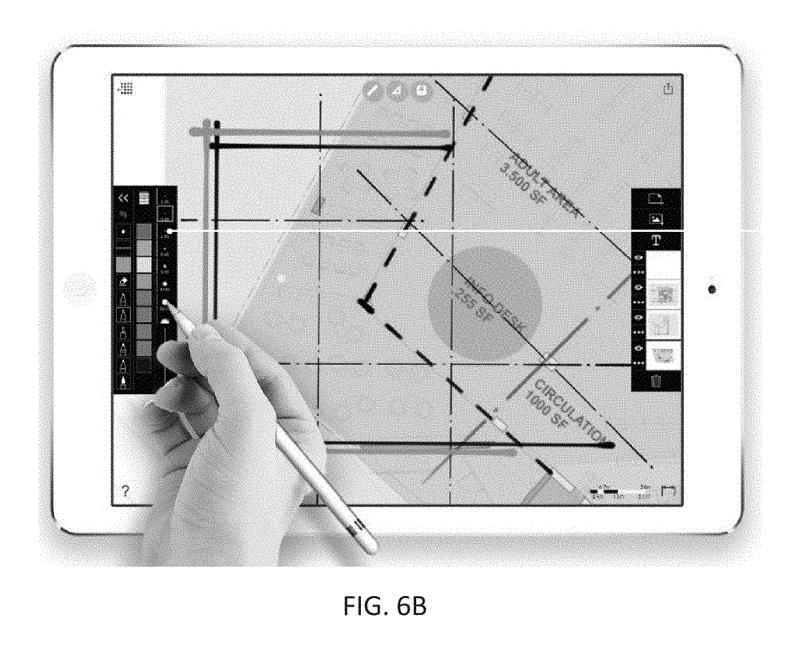

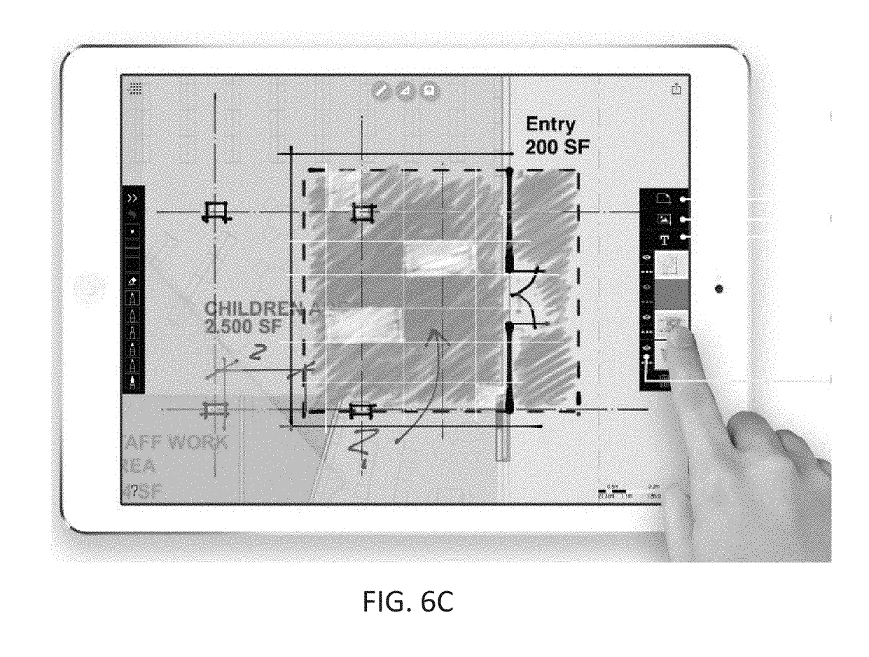

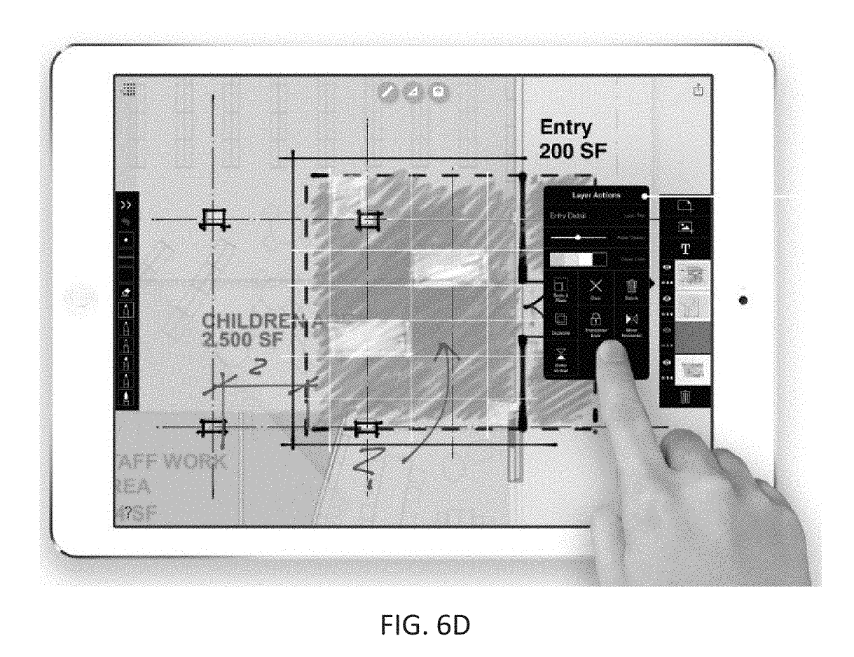

FIGS. 6A-6D represent screen shots of a user interface as described herein. As shown in FIGS. 6A-6D, the left-side menu includes various virtual drafting instrument sizes and types, as well as available colors and other tools. The right side menu includes the layer manager and different layers for selection, as well as other tools. The center of the screen shot illustrates a bottom layer of a base architectural drawing and then multiple other layers on top that may be selected and manipulated directly through touch or through the layer manager. More particularly, FIG. 6A shows that a user is in the process of selecting particular types of drafting instruments, such as different types of brushes or pens, where the stylus is hovered over a tool bar on the left side of the screen indicating different types of virtual drafting instruments available. FIG. 6B shows that the user is engaging the preview interface on the left side of the screen with the stylus for selection of appropriate line weights for the virtual drafting instruments chosen in FIG. 6A. FIG. 6C shows that the user is initiating a one finger touch command over the layer interface on the right side of the screen for adding or switching to a layer, adding an image, adding text, hiding or showing individual layers, zooming to layer, rearranging layers, or deleting layers. FIG. 6D shows that the user is initiating a one finger touch command on an additional layer tools bar for naming, renaming, resizing, repositioning, clearing the content, deleting, copying, locking, and mirroring the layers. Of course, the user interface depicted in FIGS. 6A-6D is merely exemplary, and the present invention contemplates modifications such as positioning the layer manager or preview interface on any side of the screen (left, right, top, or bottom).

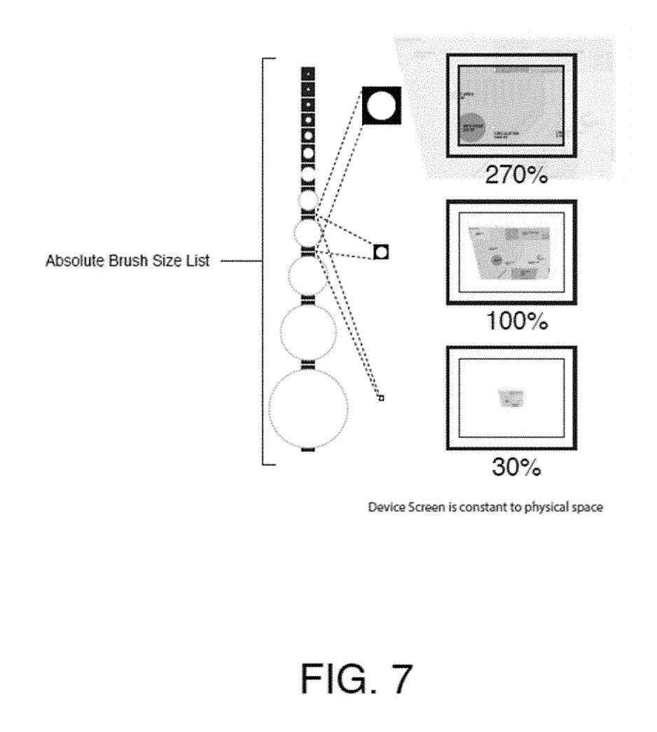

FIG. 7 is a diagram showing an embodiment in which the device display is of a necessarily fixed size in relationship to physical space. The capability to zoom on the floor plan level (shown in the diagram at 270%) and zoom out (shown in the diagram at 30%) is shown. Zooming in to 270% enlarges features of the floor plan so only the middle of the floor plan is shown, while zooming out to 100% shows the entire floor plan. Zooming to 30% shows that the floor plan only occupies a small portion of the screen, a magnification level that would be appropriate for showing the larger overall site in which the floor plan is located.

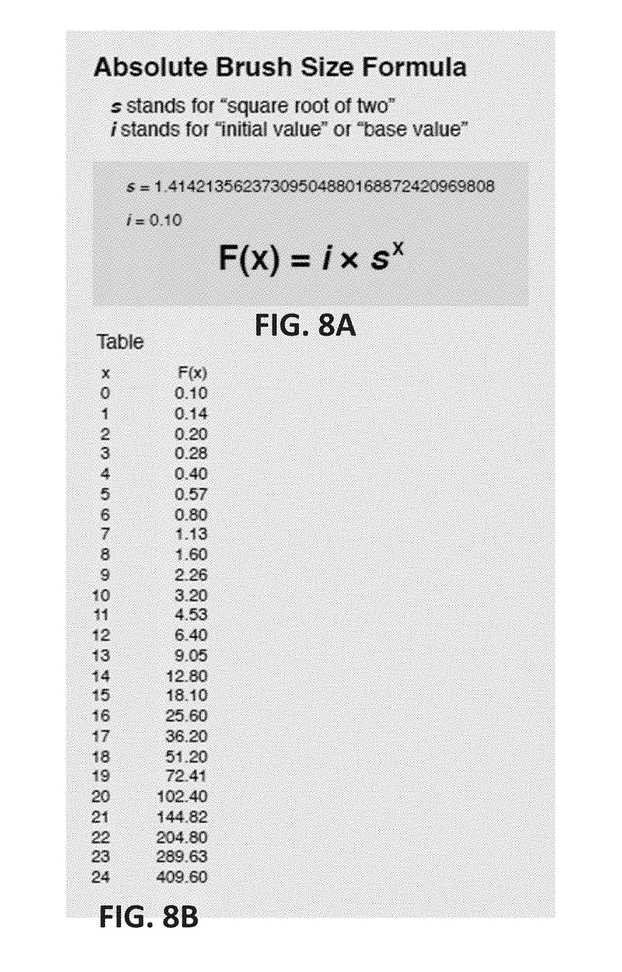

The present inventors have identified a range of absolute line weights that will cover a major span of design scales, from the smallest (e.g. design of a window jamb, tile pattern, or similarly sized features) to the largest (e.g. a landscape, building, or site plan). Drawing a line at each scale requires an appropriate and specific width, or line “weight”. FIG. 8A shows an exemplary formula for calculating the absolute line weights available to the draftsperson. In this embodiment, the line weights can be calculated as F(x)=i×s^{x}, where s stands for the square root of 2 and i stands for the initial value or base value (in this case, the base value is 0.1). FIG. 8B is a table showing the specific line weights available calculated by the formula. In this embodiment, 25 different line weights are provided: 0.10, 0.14, 0.20, 0.28, 0.40, 0.57, 0.80, 1.13, 1.60, 2.26, 3.20, 4.53, 6.40, 9.05, 12.80, 18.10, 25.60, 36.20, 51.20, 72.41, 102.40, 144.82, 204.80, 289.63, 409.60. In embodiments, the line weights can be expressed in metric (e.g. mm) or imperial (e.g. inches) units. Thus, FIG. 8B shows an example of the total number of potential line weights available. However, other embodiments may provide a smaller number of line weights or additional line weights using this formula. Further, other embodiments may provide line weights using alternative values for s and i. For example, the initial value i may be changed, or s may represent a value other than the square root of two. Thus, if i is chosen as 1.0 instead of 0.10, and s=square root of 2, the line weights would be 1.0, 1.41, 2.00, 2.83, 4.00, 5.66, 8.00, etc. If i is 0.10 and s=square root of 3 instead of 2, the line weights would be 0.10, 0.17, 0.30, 0.52, 0.90, 1.56, 2.70, etc. In embodiments of the formula depicted in FIG. 8A, the initial value i can be any number from 0.01 to 10, while s can be the square root of any number from 2 to 100. According to embodiments, a user of the software can set these values to adjust the line weights according to preference. In embodiments, the set of absolute line weights (such as those provided in FIG. 8) are stored in a database of the computing device. In an embodiment, the default paper size is 1024×768 units. Accordingly, a line weight of 10 will take up in 10 units in diameter. The conversion to inches will be to divide with “dots per inch” (dpi), here dots=units. Thus, 1024/72=14.2 inches by 768/72=10.6 inches.

As the draftsperson interacts with the software of the invention, he/she can navigate through the virtual drafting space at any magnification level. In embodiments, the present invention provides a preview interface which provides a preview of a display of the actual line weights as they would appear at that magnification. The preview interface can have a fixed horizontal width but can shift upwards or downwards in the vertical direction to provide a set of line weights appropriate for the particular magnification level chosen for the virtual scene. Embodiments of the preview interface are shown on the left side of FIG. 2, FIGS. 3A-3B, 4A-4B, and FIGS. 6A and 6B (vertical bar with progressively larger circles from top to bottom).

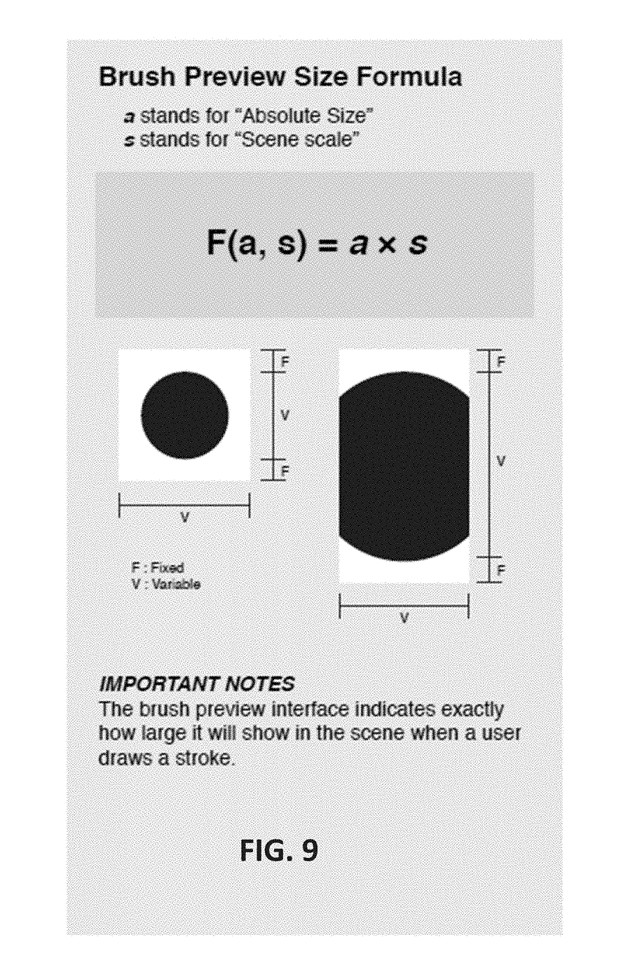

FIG. 9 shows an embodiment of a preview size formula which shows how the preview of the line weights available to the draftsperson can be calculated. In this embodiment, the preview can be calculated as F(a, s)=a×s, where a stands for absolute size and s stands for scene scale. The preview interface indicates exactly how large each line weight will show in the scene when a user draws a stroke. Thus, according to this formula, at 200% magnification, a 3.20 mm absolute line weight would appear twice as large (6.4 mm) in the preview interface (as well as on the screen when a user draws a stroke). At 50% magnification, a 3.2 mm absolute line weight would appear half as small (1.6 mm) in the preview interface. In this way, according to the formula, the brush preview maintains a direct 1:1 relationship between line weight and magnification level. However, other embodiments may rely on different formulas where the relationship between line weight and magnification level is less than 1:1, or greater than 1:1. FIG. 9 also shows variable and fixed regions on the preview interface such that a fixed margin is maintained above and below each circle on the preview interface.

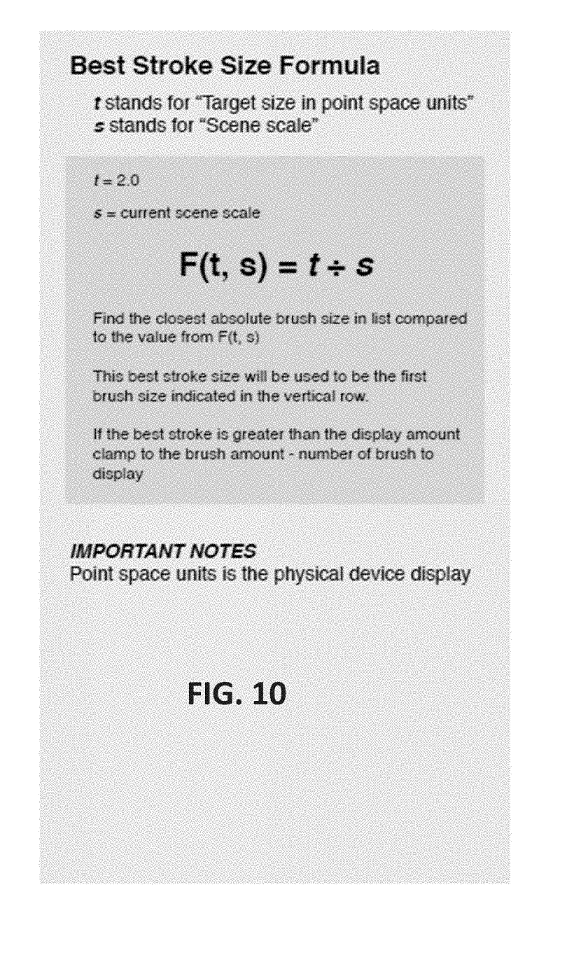

At any incidence of a scene scale change, the best line weight is calculated and the preview interface is adjusted to reflect that, giving the draftsperson feedback on an appropriate set of line weights to choose from. The best set is based on the target width of the “brush” or “pen” according to the current magnification of the scene. In other words, the best line weights would be a range of lines that the draftsperson would usually see on paper as on the screen. The algorithm for determining the best or most appropriate set of line weights determines the appropriate sized line weight from the set of absolute line weights, and chooses a size that would be at a minimum around 1-2 points or pixels in screen space and the following line weights that fit in the preview interface to display. This algorithm is shown in FIG. 10. Thus, in one embodiment, the best or most appropriate set can be calculated using the formula F(t,s)=t/s, where t stands for “target size in point space units” and s stands for “scene scale”. The algorithm finds the closest absolute “brush size” or line weight in the list compared to the value form F(t,s) where t=2.0. This best line weight is used to assign the first brush size indicated in the preview interface. The program subsequently populates the preview interface with a set number of larger brushes to display the “best set” of line weights. Thus, if the scene scale is 50%, the formula would calculate a value of 4, which would indicate that the minimum line weight for that level of magnification from the table in FIG. 8B is 4.53. Likewise, at 200%, the formula would calculate a value of 1.0, which would indicate that the minimum line weight for that level of magnification would be 1.13. At 100% magnification, the minimum line weight would be 2.26. Once the minimum line weight is assigned, the preview interface is graphically populated with that line weight and a set of successively larger line weights chosen from the absolute set of line weights available. Thus, at 100% magnification, the line weights displayed on the preview interface chosen from the absolute set of line weights listed in the table of FIG. 8B would be 2.26, 3.20, 4.53, 6.40, 9.05, 12.80, 18.10, for a set of seven line weights made available to the draftsperson or user for assigning to a virtual drafting instrument such as a pen or brush.

Alternatively or in addition to these embodiments, the program may be configured to allow a draftsperson to zoom in or out from one zoom level and location to any other particular location in a particular layer or set of layers, and receive a new set of available line weights appropriate to that magnification. Then, when the draftsperson returns to the previous location in the layer, the line weights are recomputed with the result that the set of line weights returns to the original set provided at the original magnification.

In embodiments, once a particular line weight of the virtual drafting instrument is chosen by a draftsperson, lines with that particular weight are drafted onto the virtual scene by simply moving a stylus, finger over the multi-touch interactive screen. Alternatively, other input devices such as a mouse can be used for creating lines.

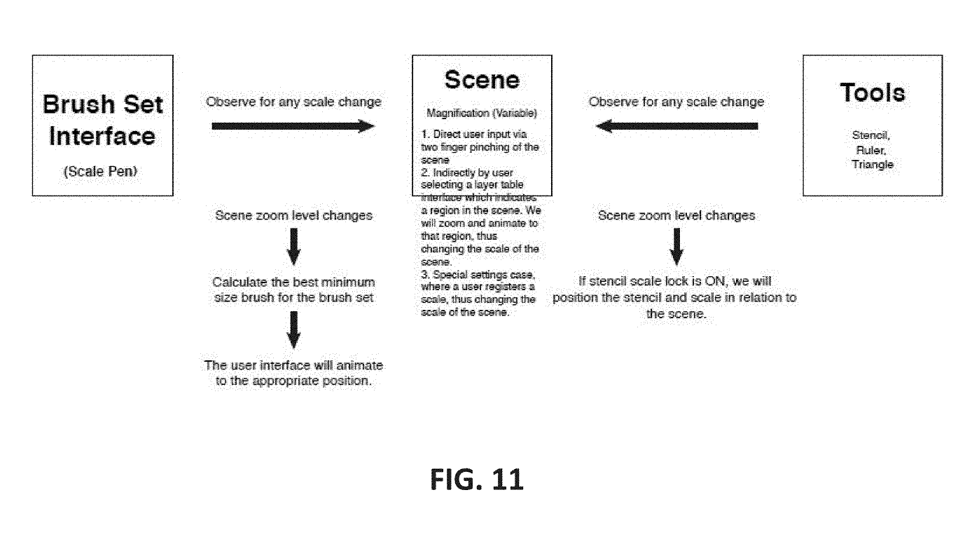

FIG. 11 is a schematic diagram which provides a summary of the foregoing disclosure. A preview interface (brush set interface) as described herein is provided. The program observes for any scale or magnification change in the scene that is displayed on the computing device. In this embodiment, as the scene zoom level changes, the best minimum size line weight for the set of line weights is calculated. The preview interface then animates to the appropriate line weight (represented by circles in the preview interface) to reflect the best or an appropriate minimum line weight. The preview interface then includes larger line weights based on this minimum line weight which make up a “set” available for the draftsperson to choose. The set can be an arbitrary number of line weights (such as 2, 3, 4, 5, 6, 7, 8, 9, 10) or can be based on the amount of display on the preview interface. The draftsperson can then select a particular line weight to assign to a particular pen or brush type. The scale change in the scene can be initiated through finger gestures or any other touch or non-touch input, such as selecting a particular scale, or by selecting a layer.

FIG. 12 shows exemplary touch commands or hand gestures for initiating various commands on the user interface. Exemplary gestures include a one finger tap for tool selection, one finger press and hold for editing layer and project order, two finger drag to pan project, two finger pinch to zoom and scale images, three finger tap to hide tool bars, and three finger drag to move a layer.

Turning now to other scale features provided by embodiments of the invention, in a preferred embodiment, a user would load an architectural blueprint or template into the underlying virtual environment. The user would then, using, for example, an input marker, create two points in the blueprint in the virtual environment for which the user knows the actual measurement, such as distance, in the physical, real, non-virtual world. This distance would be entered for the input marker, then every other tool from rulers to drafting triangles to pen weight/thickness would adjust for the distance depending on where the user is working within the virtual space; accordingly, the space of the virtual environment and objects in the space adjust to one another so that an appropriate space-scale relationship is maintained. For example, if the user zooms in, a ruler and drafting triangle will adjust so that ten feet at the zoomed out level will be 5 feet at the zoomed in level if the user zooms in at a 2× zoom level; ten feet at the zoomed out level will be approximately 3.33 feet at the zoomed in level if the user zooms in at a 3× zoom level; ten feet at the zoomed out level will be 2.5 feet at a 4× zoom level; ten feet at the zoomed out level will be 2 feet at a 5× zoom level; ten feet at the zoomed out level will be 1 foot at a 10× zoom level; and so on. Similarly, the user may zoom out and the scale will adjust such that ten feet at the zoomed in level will be calculated as 20 feet if the user zooms out at 2×; ten feet at the zoomed in level will be 40 feet if the user zooms out at 4×; ten feet at the zoomed in level will be 60 feet if the user zooms out at 6×; and so on. A similar readjustment will occur for other tools after the input marker is set. Thus, the user will not have to adjust scale or change any parameters relating to the tools regardless of where in the space-scale framework the user is working. Scale information propagates to all layers and other drawing elements in the scene as well as scale-sensitive tools such as rulers, stencils and triangles. In a preferred embodiment, the system covers an initial scale registration procedure, scale synchronization of layers and a system for drafting that preserves the scale relationships of the scene, its contents and a series of embedded or floating tools. The contents of the scene (for instance individual layers) are allowed to be moved (translation) through gesture input (see, e.g., FIG. 12) but are scale-locked by default, meaning a two-finger pinch will only serve to change the magnification of the scene, and will not increase the size of a layer. Alternately, a user may elect to “size and place” (see, e.g., FIG. 6D) a layer which will allow gesture-based scaling of the layer, though consequently breaking the scale relationship between the re-sized layer and other existing content. System visual embodiments include a registration system as well as multiple visual indicators (such as a ruler) that give live updates to scale changes and provide the user with an ambient awareness of relative scale while drawing. These visual embodiments are accompanied by a specific default configuration of layers or other drawing elements so that their response to gestures preserves their scale relationship, for instance removing the scaling component from a two or three finger gesture that might include scaling, rotation, and translation information, allowing a layer to be modified through typical gestures while preserving its overall size and scale relationship with other scene contents.

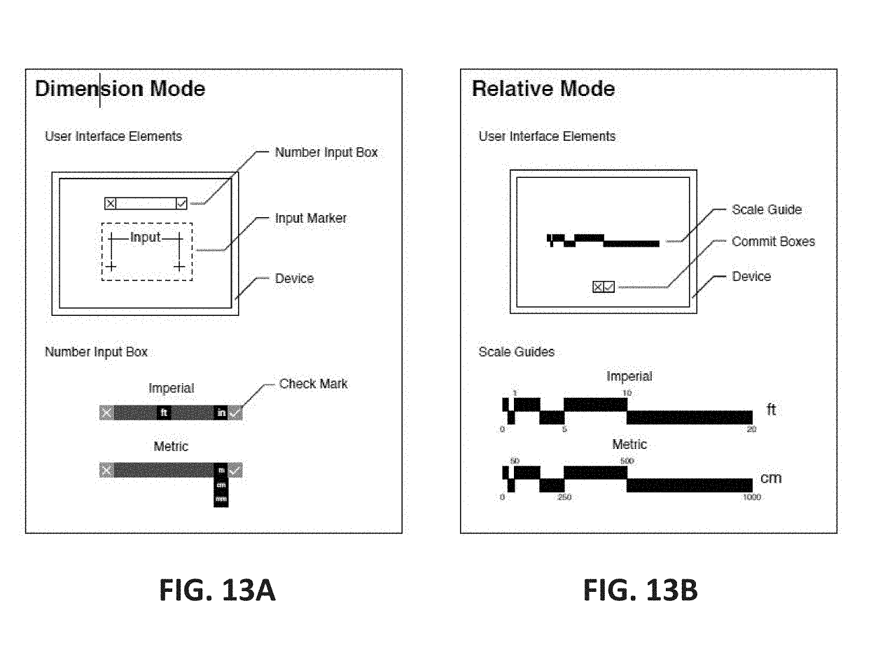

In a preferred embodiment, a scene or blueprint, by default, has a “scale registration factor” (SRF) value of 1.0 (floating point value). In order to have a correlation between the presented screen coordinates to an actual physical dimensional space, the program, in a preferred embodiment, uses a scale factor, or the so-called SRF. Two preferred methods of deriving this SRF from user input are specifically taught herein. In what is referred to as the “Dimension Mode,” the claimed algorithm teaches at least two inputs, although more are contemplated. First, a provided “input marker” is adjusted to correspond in the virtual scene to a known measurement in physical dimensional space. For example, the input marker may be two points for which a known distance value between those two points has been measured in the real-world. Second, a numerical value is entered/input in the virtual environment either in imperial or metric numbers for that “distance” between those two points. By way of example, that value may be entered in the “number input box” as shown in FIG. 13A. After pressing the “check mark” as shown in FIG. 13A, by way of example, the user may calculate the appropriate SRF to assign to the project which will also reconfigure the brush set and other elements of the user interface, such as a ruler or drafting triangle. A so-called “Relative Mode” can be operated using only one input, specifically adjusting the scene with a two finger pinch action (or otherwise) to zoom in or zoom out to the level in which the static “scale guide” most appropriately resembles its correct scale in relationship to existing drawings or elements of the scene, as shown in FIG. 13B. Once the desired scale is achieved, the user will click the pictured “check mark” in the “commit boxes” and the program will calculate the appropriate SRF to assign to the project. Thus a relationship is set or assigned in this example, between distance in the virtual environment and distance in the non-virtual environment.

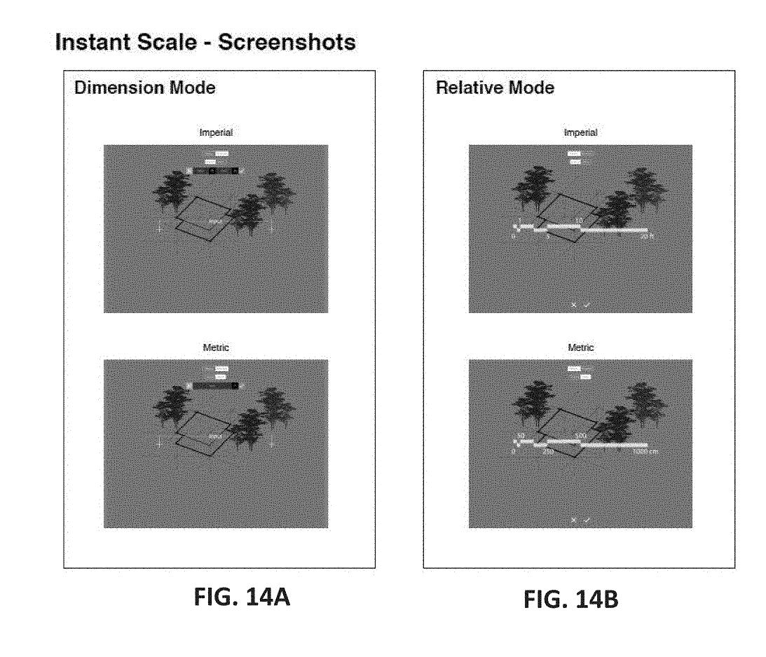

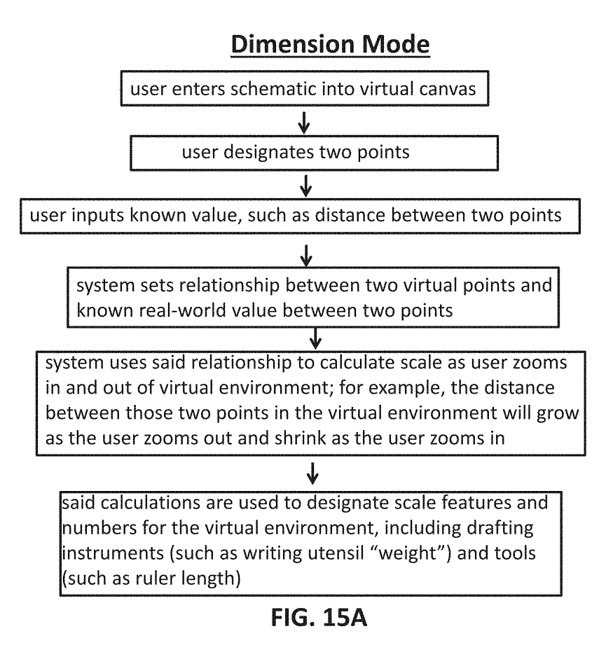

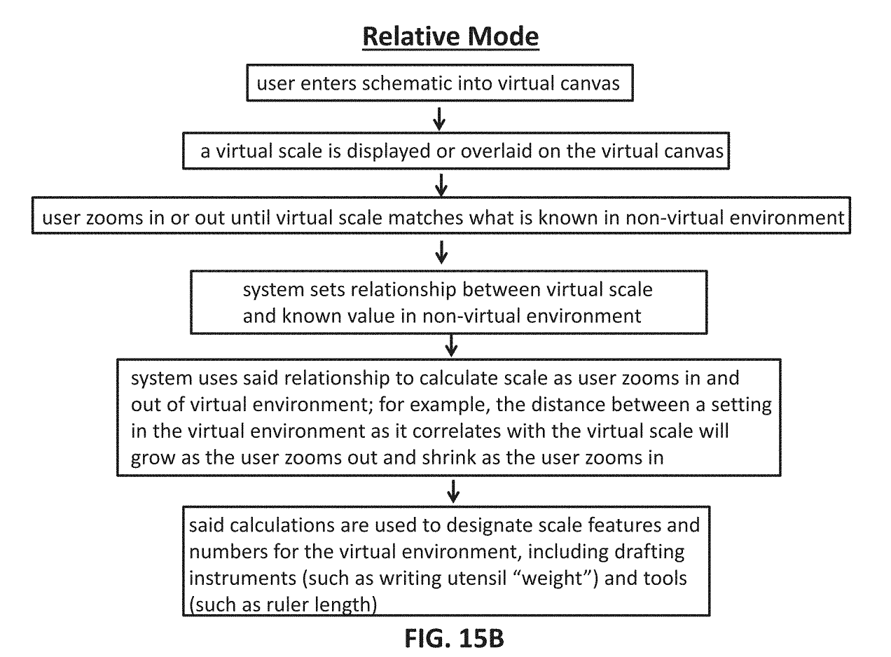

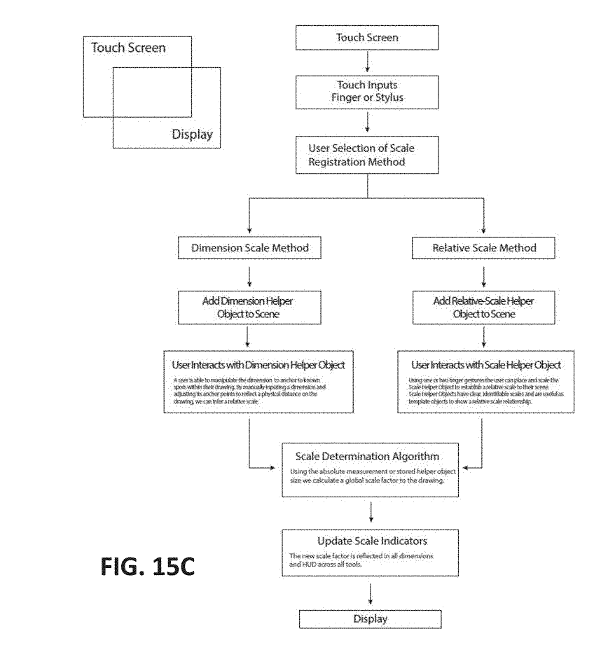

FIG. 13A shows other aspects of the “Dimension Mode.” Specifically, in one embodiment, the user pulls up an input marker and places the two exemplified points at the ends of a portion of the virtual embodiment, such as at the ends of a wall in an architectural blueprint on the virtual canvas, for which a distance is known between those two points in the non-virtual environment. The user, for example, can drag and drop the crosshairs shown (known as dimension end points represented by crosshairs); zoom in or out with a two finger pinch gesture to adjust the region in the crosshairs; or resize a given distance between two provided crosshairs. That distance is entered into the number input box and the relationship between the distance on the two points is set and recalculates to appropriate scale depending on where the user is in the virtual environment, such as when the user zooms in and zooms out. FIG. 13B also shows another aspect of setting dynamic scale for which a scale guide is overlaid on the virtual environment. (See also, FIGS. 15A and 15B, showing flowcharts of representative “Dimension Mode” and “Relative Mode” dynamics.) In the “Relative Mode,” the user zooms in or zooms out of the virtual environment until the scale, typically a static scale, although the scale can be based on any object with a known or approximate scale, size, height, distance, width, etc. in the non-virtual world (e.g., a scale figure), most appropriately resembles its correct scale in relationship to existing drawings or elements of the scene. Once a match is achieved, the user presses the check mark to commit, or set the relationship, which recalculates as the user zooms in and zooms out of the virtual environment. FIGS. 14A-B show how these scaling models might look in a screenshot of the virtual canvas, showing how it might appear using “Dimension Mode” and, alternatively, “Relative Mode.” (See also, FIG. 15A showing a flowchart of an embodiment of “Dimension Mode” dynamics, and FIG. 15B showing a flowchart of an embodiment of “Relative Mode” dynamics, and FIG. 15C showing flowcharts of both “Dimension Mode” and “Relative Mode” in process terms.)

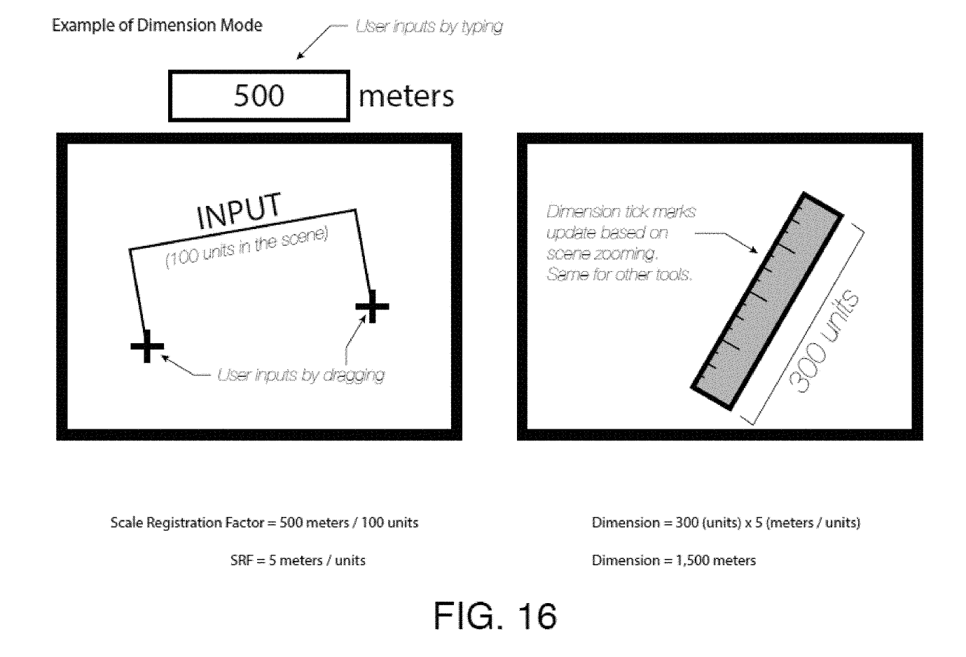

Once committed in either the “Dimension Mode” or “Relative Mode,” the system checks if the inputs are satisfied. If complete, the SRF is calculated; if not, the system typically cannot proceed. The calculation will take the input marker values or static scale values that are now correlated to the scene in the virtual environment, such as the distance between the two crosshairs or the distance indicated on the static scale. The value is based on a “general space coordinate” (GSC). Combined with the “input numerical value” (INV) which is a number with a user defined unit of imperial (ft-in) or metric (m, cm or mm), data can be used to calculate the SRF (e.g, the input numerical value is divided by the input marker value or static scale value). (See, e.g., FIG. 16.) This value is then used to indicate through the ruler, drafting triangle, or the scale registration bar the correct dimension in the virtual scene no matter what zoom level is being used.

In the “Dimension Mode,” in a preferred embodiment, an input mark value is chosen by, for example, choosing two points in the virtual environment when a distance is known between those two points in the real, non-virtual world. Then, an INV is entered, such as the known distance (e.g., in feet) for the physical and now virtual distance between those two input mark value points. An SRF is determined and, in a preferred embodiment, the input mark value and INV are entered when the SRF is 1.0, although they may be entered at different SRF values. To calculate the SRF, a computer or other processing means calculates the dots per inch, also conventionally referred to in the industry at “dpi.” The dpi is calculated constantly and seamlessly by the algorithm taught herein, whereby a computer or other processing means is necessary to continuously calculate that number almost immediately in order to render the process from the user's perspective without having any delay or lag. The dpi, in a preferred embodiment is measured by the following exemplary equation, dpi=1.0 divided by 72.0. The SRF is then calculated according to the following exemplary equation, the input marker value divided by the INV multiplied by the dpi. As the user zooms in and out of the schematic, these calculations are happening in near-immediate time and thereby require a computer to implement the algorithm taught herein.

For the “Relative Mode,” a scene scale value is chosen by zooming in and out with fingers, for example, on a touch screen and static scale guide values are offered, although the scale guide does not necessarily have to be static, and the system can be reversed to allow for scaling of the scale guide and fixing the scale of the canvas. Once a visual representation is shown of a figure of known dimension, the canvas is then zoomed until the user finds the canvas and figure in visual agreement. Once confirmed the system can calculate a SRF for the entire scene from this relative relationship. In a preferred embodiment, the user is working in the virtual project working area where a virtual button to initialize the “instant scale registration” (ISR) interface is to be activated. The user activates ISR by pressing the button according to the interface overlaying the working area. The user can still interact with the working area, such as pinching to zoom. The user is dropped into the “Dimension Mode” by default, in a preferred embodiment, but the user can toggle to “Relative Mode.”

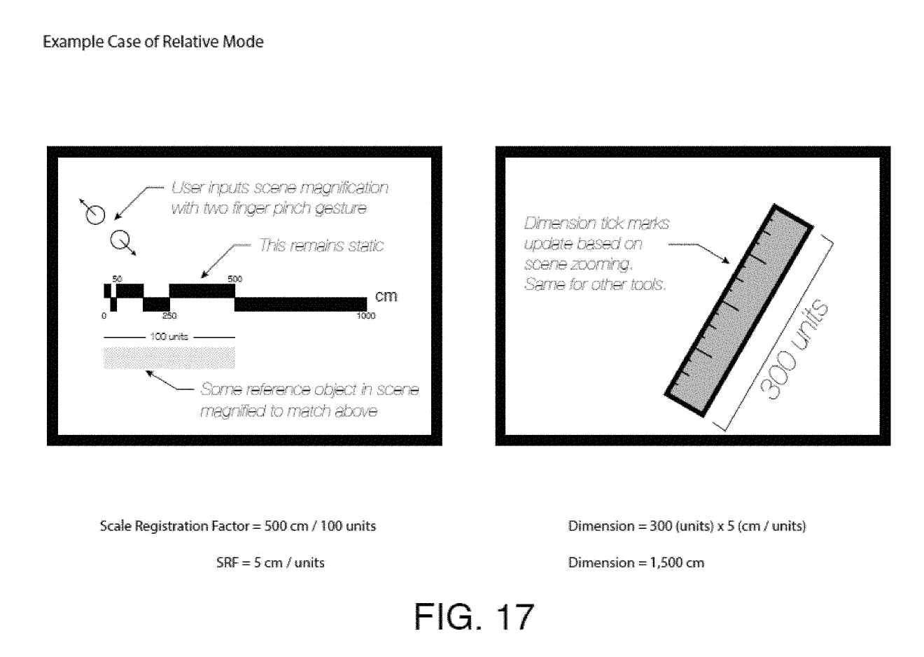

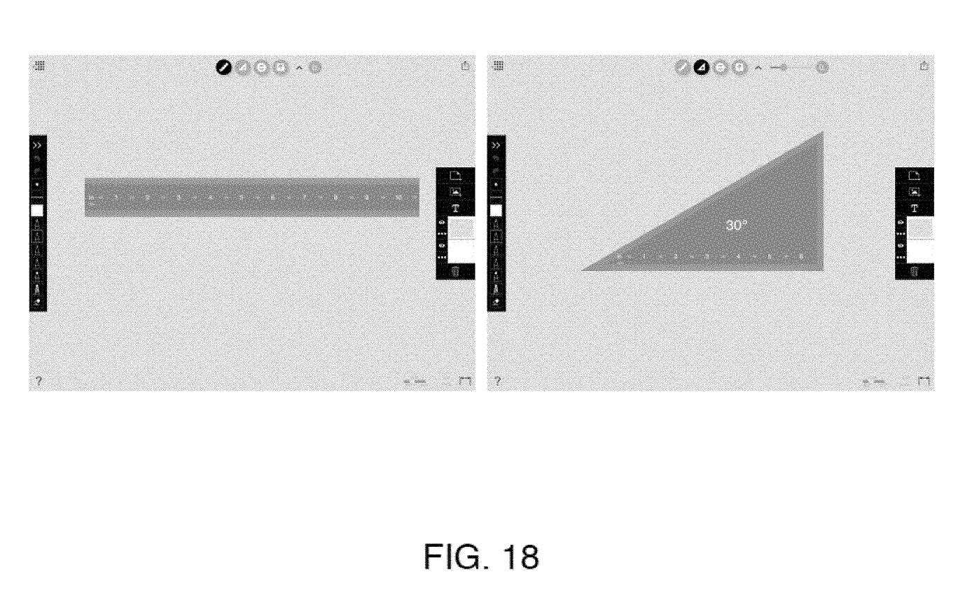

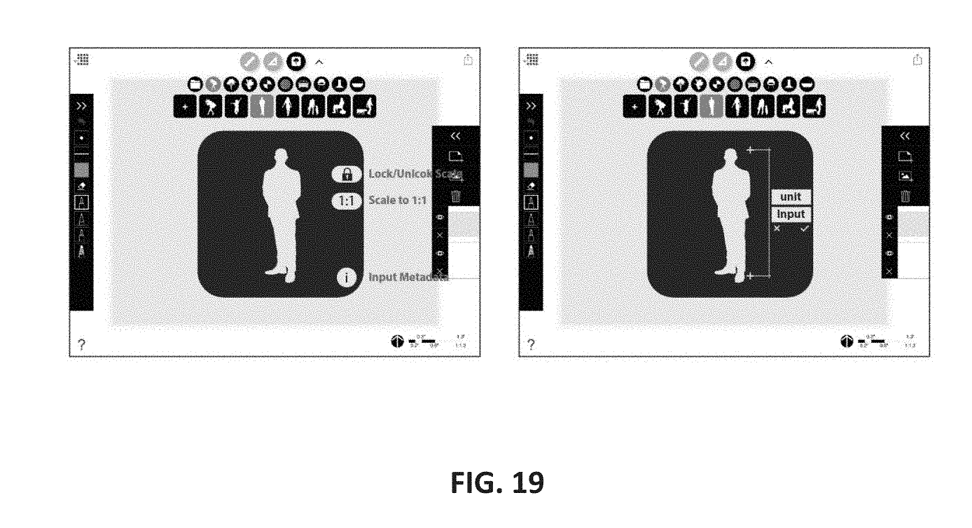

In “Relative Mode,” in one aspect, the user only needs to provide one input. That is to scale the scene until the scene visually matches the scale of an arbitrary provided figure of known dimension such as a vehicle, person, or other object. A dimension graphic or ruler/scale graphic can also serve as a figure of known dimension. In this mode, scaling the scene is performed by zooming in or zooming out until the virtual environment comes into visual agreement with the floating example object. Once the user zooms in or out to a point where appropriate scaling is achieved, meaning the scene or floating scale object (e.g., a ruler, scale figure, or anything of known or approximate scale in the real-world) approximately “fits in with” or “matches” a counterpart in the virtual canvas, the system records the current state of the scene and extracts the “scene scale value” (SSV) to determine the measurement value in the GSC it is occupying. In an embodiment, the “scale guide” has an associated value for both imperial and metric. Similar to the calculation for the “Dimension Mode,” the calculation is to divide the “scale guide” value by the GSC value which gives the SRF, and the SRF is set. (See, e.g., FIG. 17.) With reference to FIG. 18, shown is a basic illustration of tools and a scale drawing environment of embodiments described herein.

Regarding some of the virtual drafting tools in particular, such as ruler, drafting triangle, or scale registration bar, the algorithm underlying the tools determines if the main scene in the work area is being magnified (zoomed in) or shrunken (zoomed out). Changes to magnification are thus automatically propagated to tools, which adjust their dimensional call outs and tick marks to suit the new magnification. To calculate the units on the ruler, for example, the program takes the length of the ruler in GSC units and divides it by SSV in order to compute the ruler dimension in the scene. That value is then multiplied by the SRF to compute the final unit dimension to display. This is similar to the other tools, such as the drafting triangle.

The automatic scaling features, including but not limited to the “Dimension Mode” and “Relative Mode,” also pertain to an automated, dynamic stencil. The current state of the art does not provide an adequate solution to creating and utilizing image-based stencils. Stencils are an intuitive way for users to embellish drawings with patterned or figural templates. Methods described herein also preserve scale relationships between contents and encode useful metadata along with the figural aspects of applied stencils.

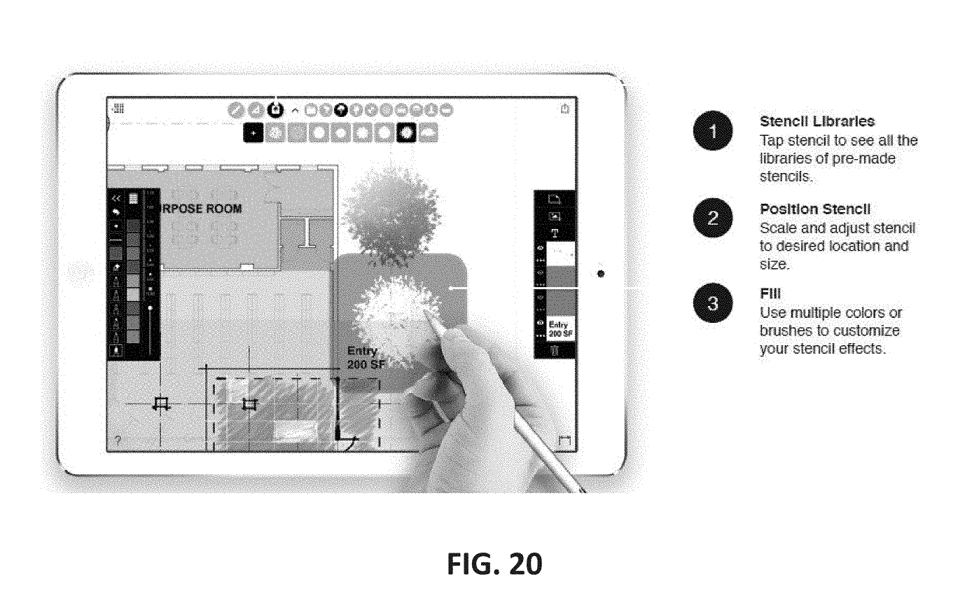

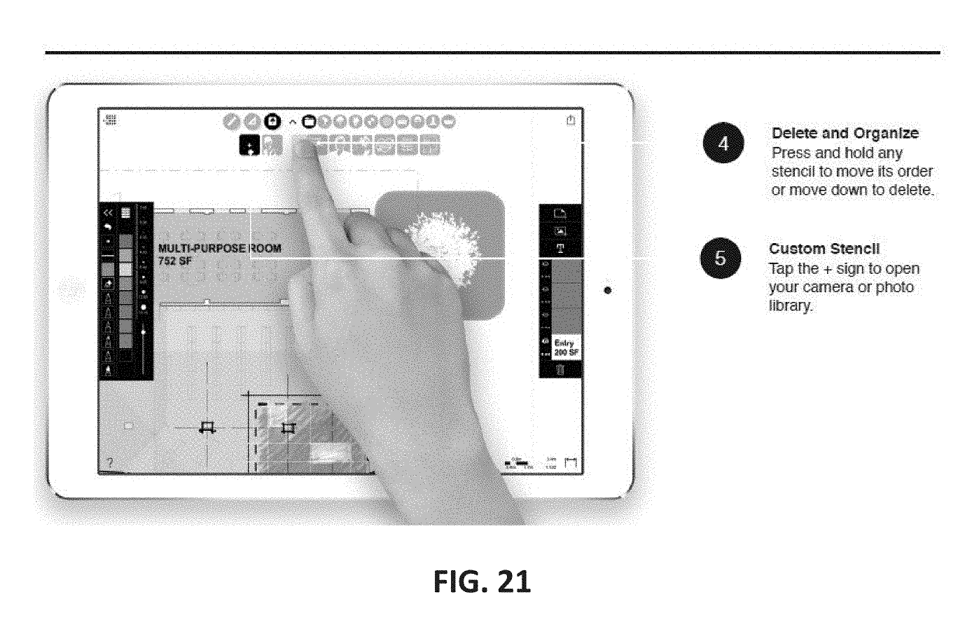

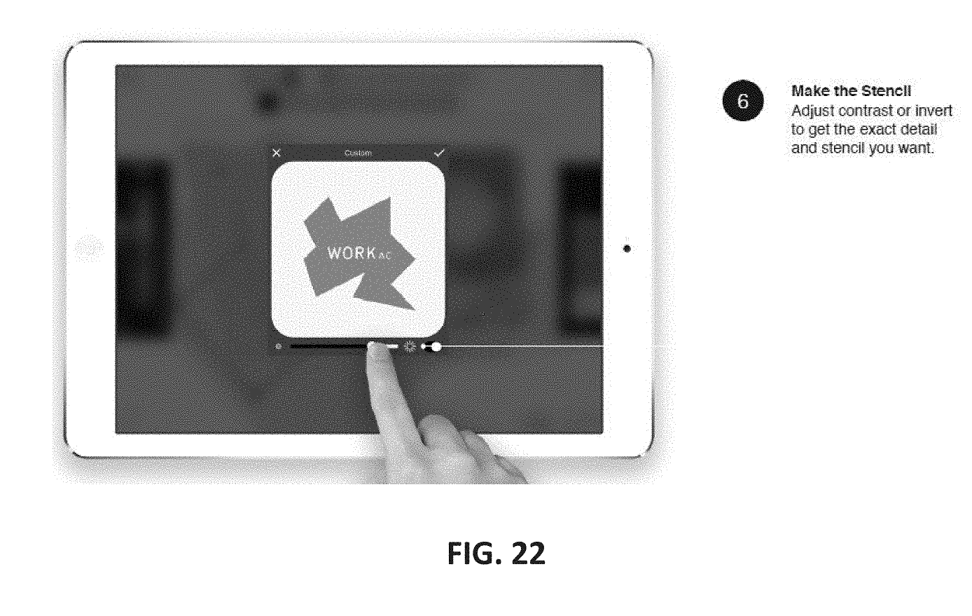

Embodiments described herein include a method for stenciling arbitrary figures onto multi-sheet drawings. Embodiments also include interfaces for providing intuitive manipulation to users, including managing scale relationships and embedded content specific metadata. With reference now to FIG. 19, shown is an illustration of a basic stencil and scale-locking user interface. FIG. 20, FIG. 21, and FIG. 22 show how the stencil feature might look on screenshots of the virtual canvas. In FIG. 20, a user is depicted manipulating a stencil on the virtual canvas. The user, in a preferred embodiment, may choose a pre-made stencil from a library of stencils by tapping or clicking on the screen. The stencil may then be dragged and dropped at the desired location on the canvas, then resized such as by pinching to zoom in or out. Once the stencil is chosen, placed, and sized, a user, in an embodiment, may draw using brushes and other tools within the region defined by the stencil without affecting the regions outside the stencil. Stencils can be chosen from a provided library, created from user-submitted images or drawings, and organized into groups for convenient access. FIGS. 20-22 show a library of stencils incorporating both provided and user-created stencils, with actions such as pressing and holding a stencil to change its order or to delete the stencil, and show how a custom stencil might appear on the virtual canvas and be manipulated, as explained in more detail herein. Further, it should be noted that the present invention contemplates other types of touch commands for initiating a zooming in or zooming out function, including a number of taps on the screen, a one finger command (e.g. swiping left or right, or up or down), and the like. The particular touch commands or gestures shown in FIG. 3A are merely illustrative, and a skilled artisan is capable of implementing a variety of different touch commands for initiating zooming in or out of any particular layer. Additionally, the present invention contemplates the use of other (e.g. non-touch) commands to initiate zooming in or zooming out, such as choosing from set values from a dropdown menu, scrolling through values on a slider, entering a specific zoom value, instructing the computer to configure the zoom so that the scene or a specific layer fills the screen, etc. The other commands can be initiated through standard devices such as a mouse or keyboard such that a multi-touch interface is not required, or can be initiated through a multi-touch interactive screen. The present invention contemplates a variety of commands for initiating a zoom function or other functions on a screen which can be appreciated by a person of ordinary skill in the programming arts.

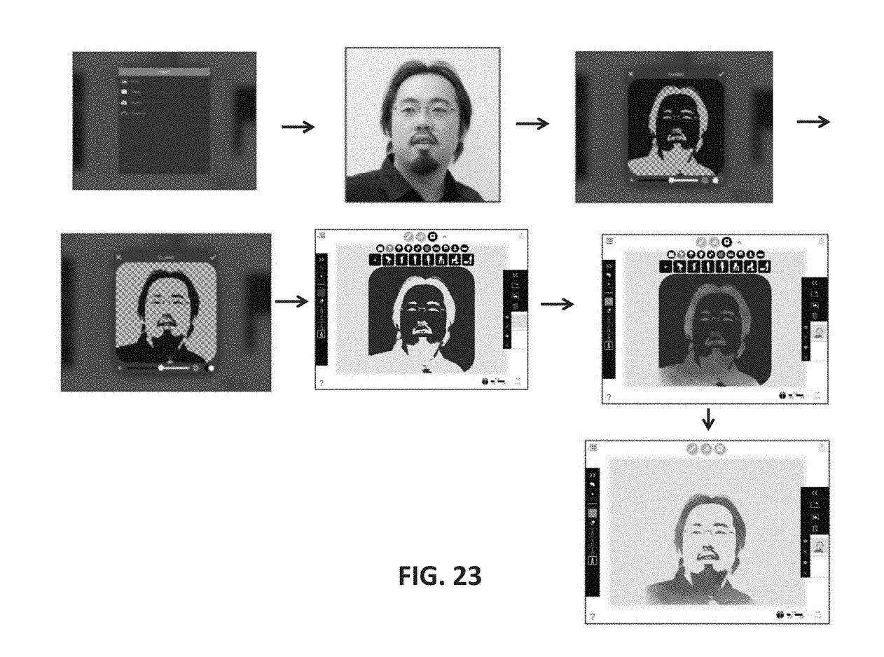

Stenciling methods enabled by embodiments may render each stencil interaction by masking the input from an interaction-specific drawing layer with the stencil contents. With reference to FIG. 23, shown is a diagram of stencil operations of an embodiment. The combined, now masked, drawing is projected onto the other drawing surfaces or can be anchored into the scene as an independent element. This method allows for undoing stencil operations by either removing the independent element, or if the stencil is projected onto lower layers, the layer contents can be restored to the prior state before projection. This method also allows for subsequent user-initiated changes to layer placement and ordering that would implicitly relocate the stenciled content as its host layers are manipulated and re-ordered.

The stencil is further capable of embedding and displaying content specific metadata. The stencil metadata can include category information such as subject matter, human, plants, etc. for future categorization. The stencil can also include 1:1 scale information to later be used to automatically adjust its size to the scene scale that the user is working in, as explained in detail herein. Provided stencils include per-pixel metadata, which is stenciled into an additional drawing-specific buffer using the same stenciling technique. A host application utilizes this information to show view-dependent contextual information such as additional product information if it is included in the original stencil.

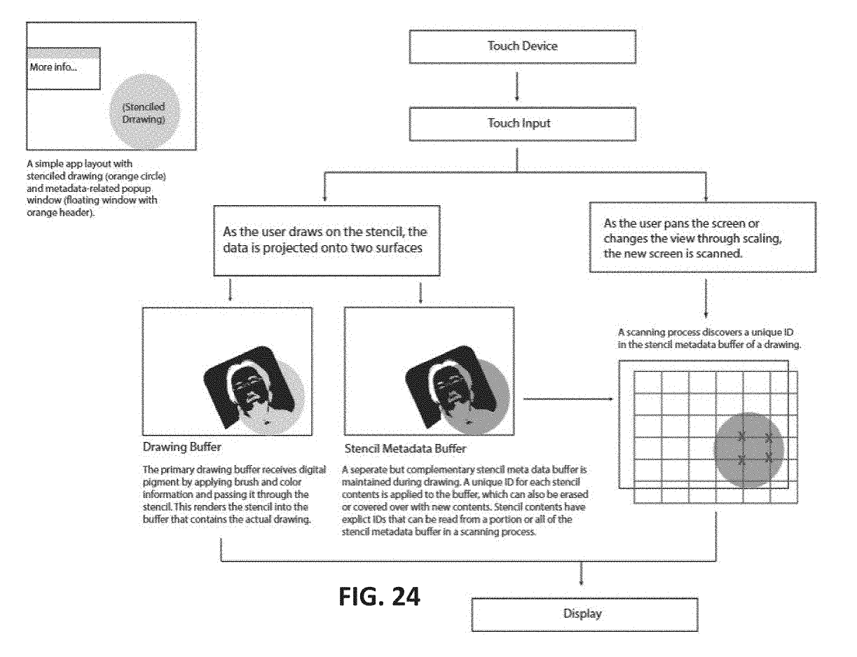

With reference now to FIG. 24, shown is an illustration of operation of stencils, including the creation and handling of a stencil metadata buffer. In a preferred embodiment, as a user draws or inputs data to the stencil, such data is projected onto two surfaces. The first surface is a drawing buffer. The drawing buffer receives digital pigment by applying, for example, brush and/or color information and passing it through the stencil. This renders the stencil into the buffer that contains the actual drawing. In a preferred embodiment, another stencil metadata buffer is also used. A unique identifier for each stencil contents is applied to this buffer, which can also be erased or covered over with new contents. Stencil contents have identifiers that can be read from a portion or all of the stencil metadata buffer in a scanning process. As a user pans the screen or changes the view through scaling, the new screen is scanned, which finds the unique identifier in the stencil metadata buffer of a drawing, and this integrated data is displayed to the user.

While stencils can be provided, the system also allows for creation of user-defined stencils. For these custom made stencils, a user may provide an arbitrary image, which is converted automatically or through minimal guidance from the user into a stencil. With reference to FIG. 23, shown are screens and process steps illustrating the creation and use of a custom stencil. In a preferred embodiment and as exemplified in FIG. 23, first an image is selected from a source, such as a computer's hard drive. The luminance of the image, along with a user-supplied threshold value, is used to derive a corresponding black and white mask. The mask's placement and scale can then be manipulated relative to a bounding stencil rectangle or other shape. Once the placement and threshold are finalized by the user, the combined tool can be presented as a stencil that can be manipulated by the user in the drawing context. The stencil can then be used to mask subsequent drawing operations such as drawing with brushes or other tools.

In an embodiment, the user has two forms of inputs. One is the threshold slider that defines the cutting point of what is considered white and what is not. This value is between 0 and 1. The default value starts at 0.5. The second input is an invert toggle button. This is toggled when a user wants to replace the white with black and black with white, or in other words reverse the negative image.

In a preferred embodiment of the filter, the program reads each pixel in the source image and filters each of them by its luminance value (e.g., how bright the individual pixel is). An image is composed of RGB channel. A channel is commonly stored in 8-bits which gives it a range of 0-255 (256 values). A luminance value is computed from RGB values using the following formula, Y=0.2126*R+0.7152*G+0.0722*B.

If the Y value is > (greater than) the threshold value, the pixel will be white, otherwise it will be rendered black. If the user toggles the invert button, the value check becomes < (less than) and the image inverts the black and white portions of the image.

In a preferred embodiment regarding custom stencil creation, the source image is processed on the device's GPU for real-time manipulation and visualization of the threshold slider and inverse toggle button.

Once the user commits to the custom stencil, the program saves out the pixels into an image converting the black pixels to be stored as alpha values creating an RGBA channel image. The original image provided, as well as the transform and threshold information, can be stored and then re-utilized to allow further changes to the stencil, such as adjusting the threshold or inverting the stencil. A preview of the stencil is also saved for showing in the associated stencil library.

The stencil tool may be also configured to preserve scale relationships between the virtual space and the contents of the stencil. Stencil contents may be of known or approximated scale/dimension and include the ability to scale-lock the stencil to the drawing environment. In a preferred embodiment, a user may zoom in or out of the virtual space, or increase or decrease the size of the stencil relative to the virtual space, so that the stencil size, if known or approximated, matches or approximates a real-world environment. For example, a stencil of a person may be resized so that it approximates the size of a person in the represented non-virtual embodiment. That space-scale relationship can be locked so that as the user zooms in or out of the space, the stencil size will change to preserve the space-scale relationship. Similarly, if the user resizes the stencil, if locked, the space will change dimension to preserve the relationship.

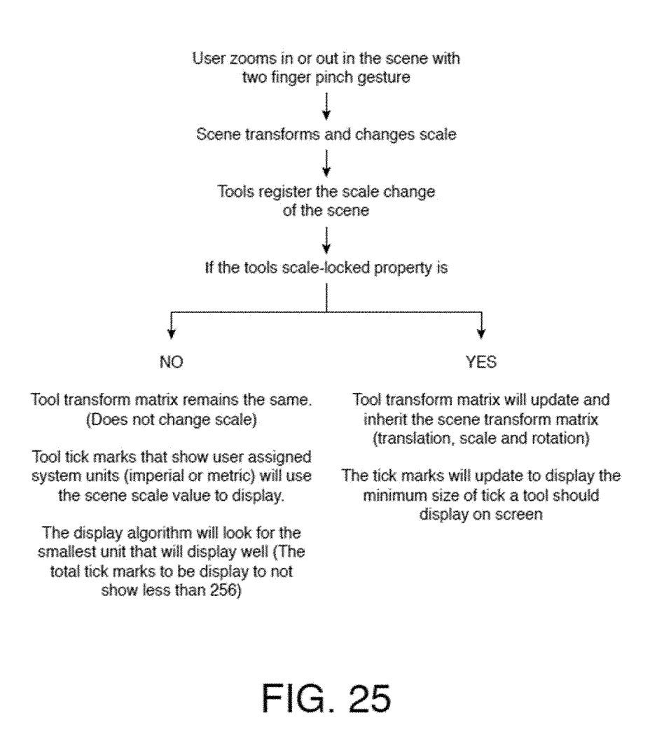

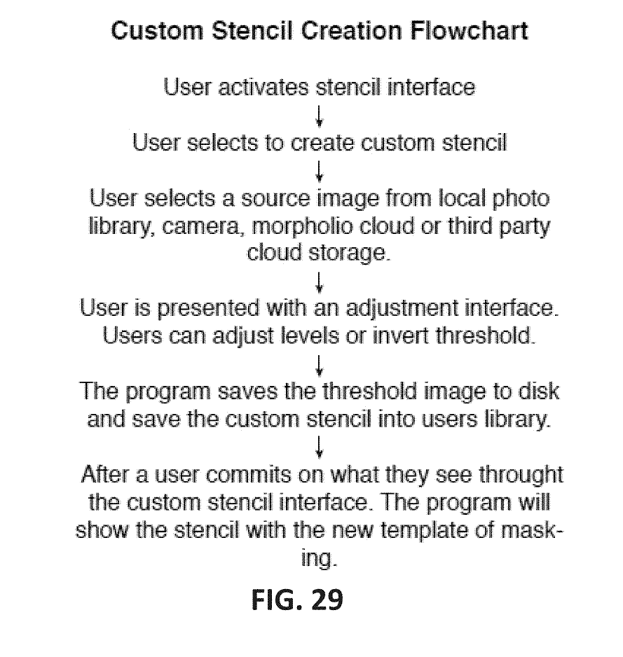

Embodiments of interfaces provided include a method/visualization for hinting scale relationships and enforcing scale consistency while stenciling. A user can toggle the on/off lock button as show in FIG. 19. In the disengaged position, the user can freely scale the stencil relative to the virtual canvas. In the engaged position, the scale is locked relative to the contents of the stencil and the canvas, so that the stencil scale remains in constant proportion to the canvas even as the user zooms in and out of the virtual environment on the canvas. When the user pinches either the scene or the stencil to scale it, the other will scale in correspondence with the manipulated element. The scale of stencil contents can be known ahead of time or input by the user. For example, a 1:1 option allows the user to size the stencil to the appropriate size relative to the scene. Provided stencils may come with the contents' scales predetermined, although they can be changed by resizing. For custom stencils, a user can define the scale through the input metadata interface. The same system can be used to override a pre-set scale on the provided stencils. (See FIG. 19.) Similarly, both “Dimension Mode” and “Relative Mode” auto-scaling features can be applied to the stencil component. Flowcharts of preferred embodiments creating, manipulating, and/or displaying a stencil as taught herein are shown in FIG. 25 and FIG. 29.

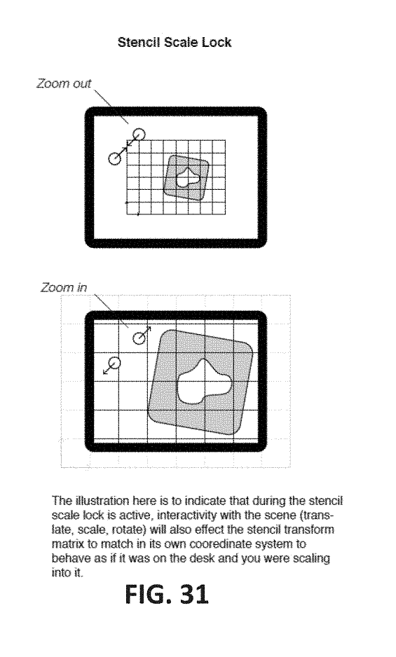

In a preferred embodiment of stencil scale interaction, the active stencil can be dynamically adjusted using horizontal mirroring, vertical mirroring, scale lock, rotation lock, inverse, and/or auto fill. Regarding horizontal mirroring and vertical mirroring, these features will take the source stencil and mirror itself according to the chosen axis of rotation. Regarding scale lock, the default setting of the stencil is that its transformation (e.g., position, scale, rotation) is independent from the scene. When this setting is active, the position of the stencil will become correlated to the scene transformation. If the scene transformation changes position, scales or rotates, the stencil will configure its transformation to match its position in the scene. (See, e.g., FIG. 31.) The mechanics include taking the scene transformation and adding it to the stencils to transform to match positioning. In one embodiment, a user's interaction begins on scene transformation (e.g., position, rotation, scale). The initial scene transformation is saved (cached) in order to calculate the delta amount of transformation from the start of interaction. This delta transformation amount is applied to the stencil transform. Stencil Transformation=Stencil Transformation×Delta Scene Transformation.

Regarding scale rotation, this function limits the user from rotating the stencil while still allowing translations. This allows two-finger gestures or other input means to still be used to place the stencil while filtering out the effects of rotation. This is utilized for drawing repeated figures at the same scale in different places on the drawing.

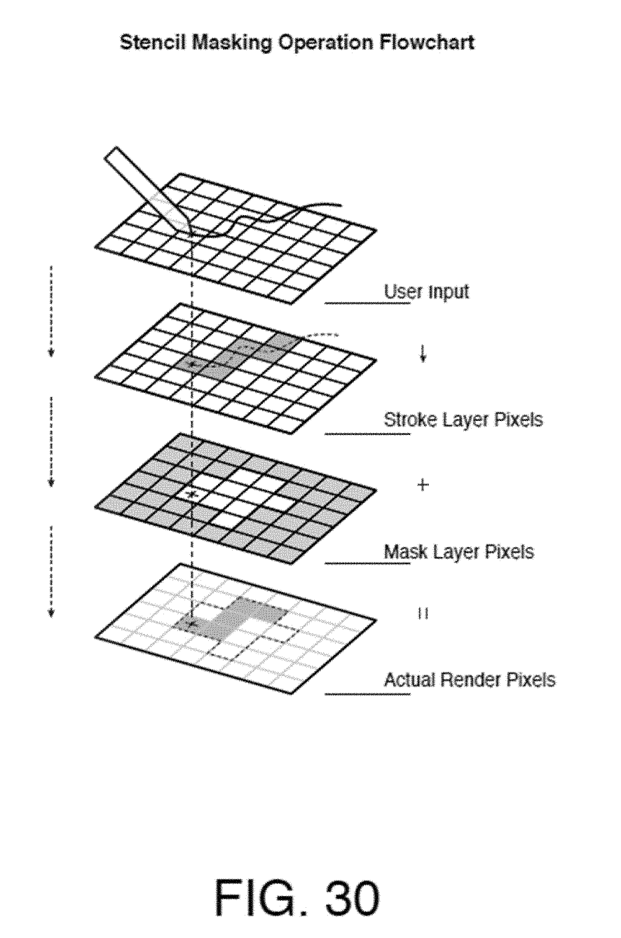

The stencil can be filled with a color, user supplied brush strokes or filled with arbitrary strokes. FIG. 30 shows a flowchart of an exemplary stencil masking operation.

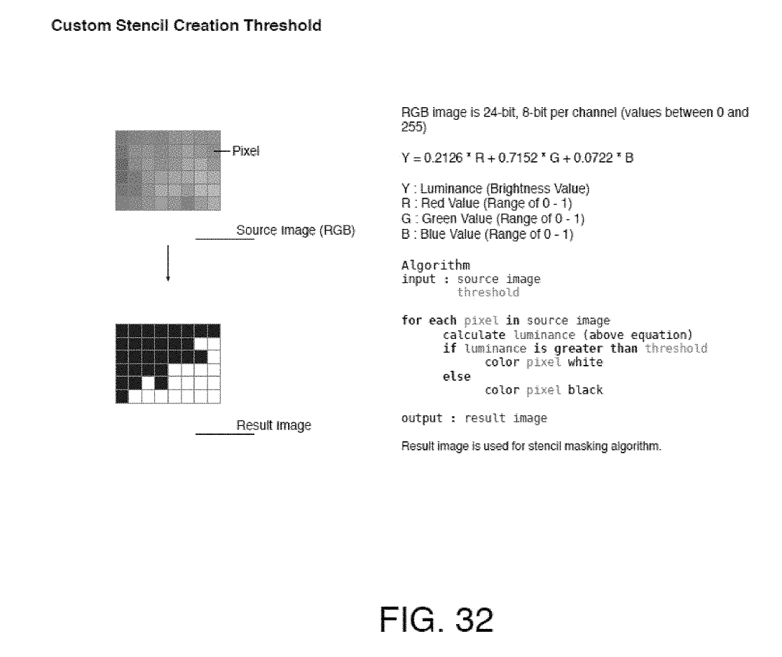

FIG. 32 is a graphic and algorithm showing a custom stencil creation threshold according to an embodiment of the invention. As shown in FIG. 32, a source image in RGB (red, green, blue) format is processed as input according to an algorithm. In one embodiment, the source RGB image is 24 bits with 8-bits per channel (values between 0 and 255). For each pixel in the source image, the algorithm calculates luminance (brightness value) according to the equation Y=0.2126×R+0.7152×G+0.0722×B, where R, G, B values can range from 0-1. The input to the algorithm also includes a threshold value for luminance which can be set by the user. After calculating luminance for each pixel, if the luminance is greater than the threshold value, the pixel is colored white, if not, the pixel is colored black. The output is the resulting image shown at the bottom left. The resulting image is used for the stencil masking algorithm.

Objectives of embodiments described herein include a reduction of significant time for the user, by providing an extendable library of stencils from which a user can make drawings while maintaining accuracy in scale relationships and measurements.

Analog plastic tools are available in specific configurations (angles, French curves, triangles and ellipses to name a few) to aid in precision drafting. Embodiments of the system described herein are means to annotate these tools with scale signifiers such as dimensional ticks and call outs.

Embodiments described herein are methods for taking basic drafting tools including a ruler, triangle and ellipse, and allowing them to work alone or in combination to aid in precision drawing through addition of scale information and context. Each tool is annotated with dimensional registration marks. As the scale of the drawing is adjusted (change to GSF) the tools update with corresponding changes to tick marks. Tools can be locked to the canvas to maintain their scale relationship with the scene. Alternately, tools can float on top of the drawing canvas. If floating, zooming in and out of the canvas creates corresponding updates to the tick marks and dimension callouts on the ruler.

Concerning the tool dimension tick mark system, and as described in FIG. 11, the tools (such as the ruler, triangle, scale registration bar, and future tools) can be configured to observe changes to magnification of the scene relative to the viewing window of the device in for example real-time. In the event that magnification changes, FIG. 25 illustrates the general flow of the system in updating specific scale annotations such as regular dimension marks and tick marks between dimension marks. The tool may be “scale-locked”. When this property is “ON”, the tool will maintain its relationship to the scene during changes to magnification and no change to the scale annotations will be necessary. When this property is “OFF”, the tool will keep its size and location independent from the changing magnification of the scene.

The tick marks are important visual guides that must maintain legibility, both in terms of having a reasonable number of callouts and ticks to aid in dimensional drawing while the scene is scaling at arbitrary values. Dimension indicators are provided in standardized units known to the industry, and may be in imperial units (inches, feet, miles, or see table below “imperial target value table”) or metric (millimeter, centimeter, meter, kilometer, or see table below, “metric target value table”). A combined scale factor is determined by multiplying the magnification level of the scene, the scale of the tool itself and a software-determined or user-supplied scale factor (SRF) and is used to calculate the physical dimension spanned by the tool in the virtual space. Then this physical dimension is divided by a value called “target tick mark count” (TMC), which produces a reasonable spacing between each tick mark. The TMC can be calculated by taking the edge length of the tool in screen space units and dividing it by 4.0 (though this number can be increased or decreased arbitrarily to specify for more or less ticks to appear). This idealized number of tick marks is then used to figure how far apart each tick mark would be in the dimensioned, scale-registered space that the tool covers (incorporating both the magnification of the scene and the SRF). This separating dimension is compared against a table of known and common fractional or whole dimension steps.

In embodiment, the imperial target values may include the following: 1/256 (0.00390625), 1/128 (0.0078125), 1/64 (0.015625), 1/32 (0.03125), 1/16 (0.0625), ⅛ (0.125), ¼ (0.25), ½ (0.5), 1, 2, 6, 12, and 24, while metric target values may include: 0.1, 0.2, 0.5, 1.0, 2.0, 5.0, 10.0, 20.0, 50.0, 100.0, 200.0, 500.0, 1000.0, 2000.0, 5000.0, 10000.0.

For example, if the ruler is 1024 points in screen space units, this can be divided by 4.0 to get a value of 256 for the TMC. After computing the physical dimension of the tool and dividing it by TMC, a dimensional step value is obtained that can be used to find the closest target value from the appropriate table (imperial or metric depending on the user's settings). For example, with a tool that spans 1024 units in screen space, divided by 4.0 to indicate a desired 256 tick marks, that is computed to occupy a physical dimension of 5 inches in real space (as computed by the scene scale and SRF), a distance in dimensioned space of 0.01953125 inches is computed, which would be closest to 1/64 as a standard unit. 1/64 becomes the base unit to display as the tick marks, and the number of ticks given this new tick spacing is computed and is used to annotate the tools. Thus, tick marks can vary continuously as magnification is changed (or as new SRF values are registered), tick marks are shown at appropriate visual density and always indicate standardized, industry-friendly spacing amounts.

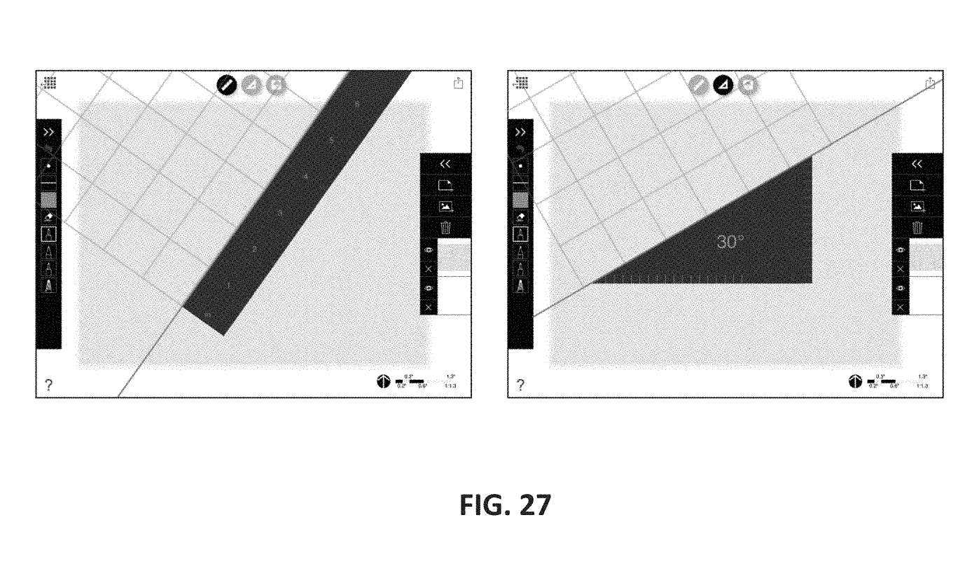

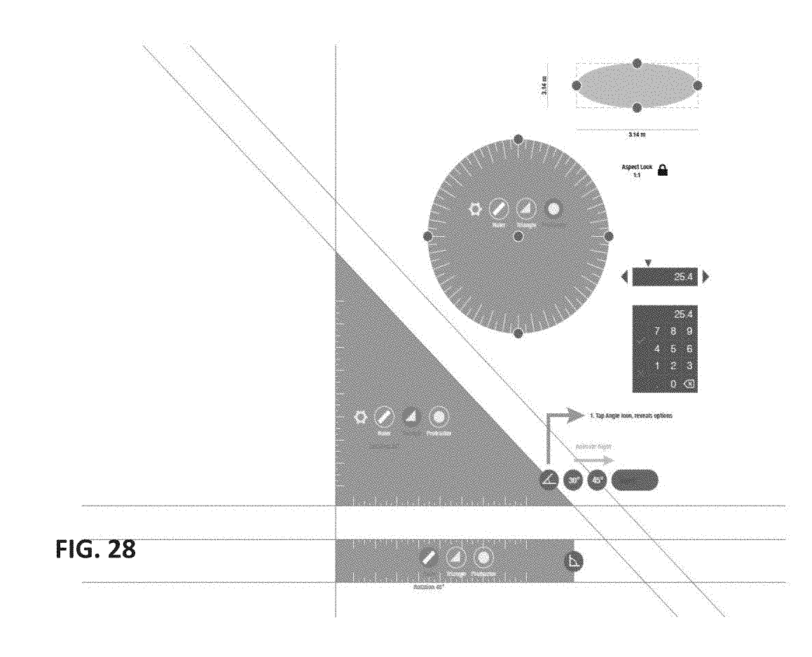

In embodiments, a guide shape is a provided shape that informs a template in which to map user touch to a more precisely defined guideline. Guide shapes include but are not limited to a right triangle, scale ruler and ellipse. Guide shapes extend their behavior beyond their immediate locale. Upon contact/request a laser line is extended from the tools signifying the distance beyond the tools in which the user can draw. These laser lines can be extended into a grid and overlaid with other tool grids. With reference now to FIG. 27, shown are illustrations of the laser line and grid guidelines provided by embodiments.

Specific guide shapes have per-shape configurations for additional ease of use and shape-specific constraints. A triangle tool contains an adjustable angle defined by a rotating dial that provides visual alignment hints. The tool can be configured to snap to regular degree increments or a user-defined degree can be input. A visual indicator at the center of the triangle toggles the visual display of the dial and other secondary inputs. The ellipse has four points to extend a perfect circle into any given ellipse in which the center of the ellipse contains a dashboard signifying the specifications of the set ellipse.

With reference now to FIG. 28 shown is an embodiment of the triangle and ellipse tools. These tools react to each other allowing the tools to work together for specific drawing objectives, such as dragging a triangle along a ruler. Objectives of embodiments described herein include a reduction of time for the user, the ability to use multiple tools together to synthesize layouts and the increase in dimensional precision with any given set of pens or brushes.

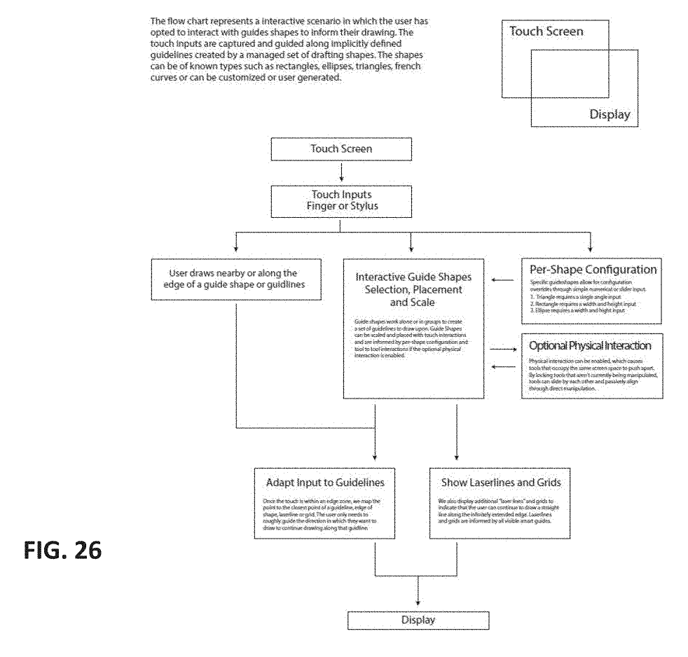

With reference now to FIG. 26, shown is a flow diagram illustrating various process flows implemented by embodiments of the tools described herein; specifically, it illustrates process steps of a method of using an embodiment of the shape guides/smart drafting tools described above. In a preferred embodiment, on a touch screen a user will use touch inputs, such as a finger or stylus. A user may draw nearby or along the edge of a guide shape or guidelines. A user may also use interactive guide shapes to select, place, and scale certain shapes in relation to the virtual canvas. Such guide shapes work alone or in groups to create a set of guidelines. The shapes, which can be scaled and placed with touch interaction, are informed by per-shape configuration and tool-to-tool interactions if the optional physical interaction is enabled. For example, regarding per-shape configuration, specific guide shapes allow for configuration overrides by way of numerical or slider input. In one aspect, a triangle requires a single angle input. In another aspect, a rectangle requires a width and height input. In another aspect, an ellipse requires a width and height input. Regarding optional physical interaction, the system may enable such a feature, which causes tools that occupy the same screen space to push apart. By locking tools that are not currently being manipulated, tools can slide by each other and passively align through direct manipulation.

User input is adapted to guidelines. Accordingly, once the touch is within an edge zone, for example, the system maps the point to the closest point of a guideline and/or edge of a shape, laser line, and/or grid. A user only needs to roughly guide the direction in which the user wants to draw to continue drawing along that defined path. Laser lines and gridlines may also be displayed to indicate that the user can continue to draw a straight line along the infinitely extended edge. Such laser lines and grids may be informed by some or all of the visible smart guides.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A method of computer-aided drafting, comprising:
providing a first set of virtual writing instruments;
providing a virtual environment at a selected magnification level;
determining a change in the magnification level of the virtual environment; and
providing a second set of virtual writing instruments in response to the change.

2. The method of claim 1, wherein:
the second set of writing instruments comprises at least one writing instrument with a line weight that is not available in the first set; or
the first set of writing instruments comprises at least one writing instrument with a line weight that is not available in the second set.

3. The method of claim 1, wherein the first or second set has at least one writing instrument:
(i) with a line weight that is different from a line weight of any of the writing instruments in the other set of writing instruments, and
(ii) with a line weight that reflects the minimum line weight appropriate for the magnification level of the virtual environment.

4. The method of claim 1, wherein:
each of the writing instruments has an associated line weight; and
the smallest line weight available to a user is the smallest line weight appropriate for the magnification level of the virtual environment.

5. The method of claim 4, wherein the smallest line weight is 2 pixels wide.

6. The method of claim 1, further comprising updating a user interface with a graphical display of the first and/or second set of virtual writing instruments.

7. The method of claim 1, wherein the virtual writing instruments are color coded to correspond with a particular line weight.

8. The method of claim 1, wherein one or more of the writing instruments has an associated line weight and one or more of the line weights differs from another of the line weights in the set of writing instruments by a factor of the square root of 2.

9. The method of claim 8, wherein one or more of the line weights is calculated according to the formula: F(x)=i×s^{x}, where s stands for the square root of 2 and i stands for the initial value or base value.

10. A method of providing scale using a computer, comprising:
providing a virtual environment;
determining the magnification level of the virtual environment;
receiving user inputs on a defined value between two points in the virtual environment, or providing a predetermined scale displayed in the virtual environment;
setting a space-scale relationship between the determined magnification level of the virtual environment and the defined value or the predetermined scale;
in response to changes in the magnification level of the virtual environment, calculating the scale appropriate for the magnification level based on the set space-scale relationship between the determined magnification level and the defined value or the predetermined scale.

11. The method of claim 10, wherein scale is provided to a stencil, shape, or other object displayed in the virtual environment.

12. The method of claim 10, wherein the predetermined scale is an object of known or approximate scale, such as a person, animal, figure, vehicle, door jamb, or scale key.

13. The method of claim 10, wherein the user inputs together represent a known distance in a real-world physical environment between the two points.

14. The method of claim 10, wherein a feature of one or more tools chosen from virtual rulers, virtual drafting triangles, virtual drafting compasses, and/or line weights of virtual drafting instruments is adjusted to a selected scale registration factor to maintain the set space-scale relationship.

15. The method of claim 11, wherein the scale is provided to a virtual stencil and the set space-scale relationship between the virtual environment and the virtual stencil applies to position and/or rotation of the virtual environment and/or the virtual stencil relative to one another.

16. A method for computer-aided creation of a virtual stencil, comprising:
providing a source image;
reading each pixel in the source image and comparing each pixel with a threshold value;
assigning pixels a white color when the pixel exceeds the threshold value and assigning pixels a black color when the pixel equals or falls below the threshold value; and
creating a virtual stencil as a black and white mask from the source image by storing the black pixels as alpha values creating an RGBA channel image.

17. The method of claim 16, further comprising allowing an option to accept more or less of the source image through adjustment of the threshold value to create the virtual stencil.

18. The method of claim 16, wherein the virtual stencil is configured to preserve scale relationships between a virtual environment and content of the virtual stencil.

19. The method of claim 16, wherein the virtual stencil is configured to be adjusted using horizontal mirroring, vertical mirroring, scale lock, rotation lock, inverse, and/or auto fill.

20. The method of claim 16, wherein the virtual stencil is configured to allow for masking of subsequent drawing operations.
